(19) United States
(12) Patent Application Publication
(10) Pub. No.: US 2026/0198505 A1
(43) Pub. Date: Jul. 16, 2026

(54) BIOSTIMULANT COMPOSITION

(71) Applicant: Tenfold Technologies, LLC, Pilot Point, TX (US)

(72) Inventors: Neissa Maryann PINZON, Frisco, TX (US); Maud Ann WRIGHTSON HINCHEE, Little Elm, TX (US); Allana Kay WELSH, Denton, TX (US); Leslie Michelle PERRY, Fort Worth, TX (US); Curtis Brian HILL, Little Elm, TX (US); Mohammad Kamrul HASSAN, Aubrey, TX (US)

(21) Appl. No.: 19/342,878

(22) Filed: Sep. 29, 2025

Related U.S. Application Data
(63) Continuation of application No. PCT/US23/16872, filed on Mar. 30, 2023.
(60) Provisional application No. 63/455,662, filed on Mar. 30, 2023.

(51) Int. Cl. A01N 65/03; A01P 21/00

(52) U.S. Cl. CPC A01N 65/03; A01P 21/00

(57) ABSTRACT

Biostimulant compositions made by digestion of Ecklonia maxima feedstock and methods of promoting plant growth by contacting plants, plant seeds, or plant growth media with such compositions.

### CROSS-REFERENCE

This application is a continuation of International Application No. PCT/US2023/016872, filed Mar. 30, 2023, which claims the benefit of U.S. Provisional Application No. 63/455,662, filed Mar. 30, 2023, which is herein entirely incorporated by reference.

### BACKGROUND

The disclosure is generally related to biostimulant compositions and methods of using such biostimulant compositions to promote plant growth.

Promoting efficient production of food crops and other crops is an important goal for environmental and economic reasons. Plant growth promoting products sourced from organic materials can help to enhance crop growth, improve the efficacy of agricultural products, such as fertilizers, and reduce the environmental impacts of synthetic fertilizers and climate change. There exists a need for plant growth promoting biostimulant compositions that use abundant and available organic feedstocks.

### SUMMARY

The present disclosure provides plant growth promoting biostimulant compositions made from Ecklonia maxima feedstock and methods of using such biostimulant compositions.

Disclosed herein is a method of promoting plant growth comprising contacting a plant, a seed of the plant, or a growth medium for the plant, with a composition comprising microbial digestion products of an organic feedstock comprising Ecklonia maxima kelp. In some embodiments, the digestion is anaerobic digestion. In some embodiments, the digestion products are produced by microbes endogenous to the Ecklonia maxima kelp present in the organic feedstock. In some embodiments, the digestion products comprise fucose at a concentration of no more than 40 mol % in relation to all glycosyl residues in the composition. In some embodiments, the digestion products comprise xylose at a concentration of no more than 15 mol % in relation to all glycosyl residues in the composition. In some embodiments, the digestion products comprise mannose at a concentration of more than 7 mol % in relation to all glycosyl residues in the composition. In some embodiments, the digestion products comprise one or more of isobutanol, pentadecanenitrile, pentadecanoic acid, 9-octadecenenitrile, hexadecanenitrile, or heneicosane. In some embodiments, the digestion products comprise the molecular species listed in FIG. 39. In some embodiments, the digestion products comprise one or more molecular species corresponding to one or more of peaks C, F, G, J, O, or P in the LC-MS chromatogram shown in FIG. 3. In some embodiments, the digestion products comprise one or more molecular species corresponding to one or more of peaks A, B, C, D, E, F, or G in the GC-MS chromatogram shown in FIG. 4. In some embodiments, the digestion products comprise one or more molecular species corresponding to one or more of peaks A, B, C, D, or E in the ¹H-NMR spectrum shown in FIG. 5. In some embodiments, the digestion products comprise one or more molecular species corresponding to one or more of peaks A or B in the ¹³C-NMR spectrum shown in FIG. 6.

In some embodiments, the composition further comprises microbes endogenous to the Ecklonia maxima present in the organic feedstock. In some embodiments, the microbes comprise sporulated microbes. In some embodiments, the dry weight percentage of microbial biomass in the composition is from 0.071 to 0.714% in relation to the total dry weight of the composition. In some embodiments, the microbes present in the composition comprise one or more of Microbacterium amylolyticum, Thermoanaerobacterium thermosaccharolyticum, Cellulosilyticum lentocellum, Microbulbifer thermotolerans, Collinsella sp., Acinetobacter spp., Acinetobacter towneri, Lentilactobacillus buchneri, Liquorilactobacillus hordei, or Secundilactobacillus paracollinoides. In some embodiments, the dry weight percentage of microbial biomass in the composition is below 0.001 wt % in relation to the total dry weight of the composition. In some embodiments, the composition does not comprise microbes.

In some embodiments, promoting plant growth comprises one or more of the following: enhancing seed germination, enhancing early plant development, improving root growth, increasing nutrient uptake, improving tolerance to abiotic stress, mitigating transplant shock, improving plant reproduction, and improving soil microbial activity. In some embodiments, improving tolerance to abiotic stress comprises improving one or more of the following: salt tolerance, heat tolerance, cold tolerance, and drought tolerance. In some embodiments, the contacting comprises in-furrow application, foliar spray application, application to a rooting zone, application to a seed, or mixing with the growth medium. In some embodiments, the growth medium is soil.

In some embodiments, the composition further comprises solid fertilizer particles. In some embodiments, the fertilizer particles are coated by the digestion products. In some embodiments, the composition is liquid. In some embodiments, the composition further comprises a liquid fertilizer.

In some embodiments, the contacting comprises applying the composition at a rate of 0.5 to 10 quarts per acre. In some embodiments, the contacting comprises applying 0.14 to 6.7 g by dry weight of the digestion products per acre.

In some embodiments, at the time of the contacting, the plant is experiencing drought conditions or is at risk of experiencing drought conditions. In some embodiments, the growth medium is a high salt soil. In some embodiments, at the time of the contacting, the plant is experiencing freezing conditions or is at risk of experiencing freezing conditions. In some embodiments, at the time of the contacting, the plant is experiencing cold stress or is at risk of experiencing cold stress. In some embodiments, at the time of the contacting, the plant is experiencing heat stress or is at risk of experiencing heat stress. In some embodiments, the plant has been transplanted. In some embodiments, the plant is corn, cotton, tomato, or bell pepper. In some embodiments, the plant is a cotton plant or corn plant, and wherein the cotton plant or corn plant is in drought conditions at the time of the contacting.

Also disclosed herein is a composition comprising digestion products produced by digestion of an organic feedstock comprising Ecklonia maxima kelp by microbes. In some embodiments, the microbes comprise microbes endogenous to the Ecklonia maxima kelp present in the organic feedstock. In some embodiments, the digestion products comprise fucose at a concentration of no more than 40 mol % in relation to all glycosyl residues in the composition. In some embodiments, the digestion products comprise xylose at a concentration of more than 15 mol % in relation to all glycosyl residues in the composition. In some embodiments, the digestion products comprise mannose at a concentration of more than 7 mol % in relation to all glycosyl residues in the composition. In some embodiments, the digestion products comprise one or more of isobutanol, pentadecanenitrile, pentadecanoic acid, 9-octadecenenitrile, hexadecanenitrile, or heneicosane. In some embodiments, the digestion products comprise the molecular species listed in FIG. 39. In some embodiments, the digestion products comprise one or more molecular species corresponding to one or more of peaks C, F, G, J, O, or P in the LC-MS chromatogram shown in FIG. 3. In some embodiments, the digestion products comprise one or more molecular species corresponding to one or more of peaks A, B, C, D, E, F, or G in the GC-MS chromatogram shown in FIG. 4. In some embodiments, the digestion products comprise one or more molecular species corresponding to one or more of peaks A, B, C, D, or E in the ¹H-NMR spectrum shown in FIG. 5. In some embodiments, the digestion products comprise one or more molecular species corresponding to one or more of peaks A or B in the ¹³C-NMR spectrum shown in FIG. 6.

In some embodiments, the composition further comprises microbes endogenous to the Ecklonia maxima present in the organic feedstock. In some embodiments, the microbes comprise sporulated microbes. In some embodiments, the dry weight percentage of microbial biomass in the composition is from 0.071 to 0.714% in relation to the total dry weight of the composition. In some embodiments, the microbes present in the composition comprise one or more of Microbacterium amylolyticum, Thermoanaerobacterium thermosaccharolyticum, Cellulosilyticum lentocellum, Microbulbifer thermotolerans, Collinsella sp., Acinetobacter spp., Acinetobacter towneri, Lentilactobacillus buchneri, Liquorilactobacillus hordei, or Secundilactobacillus paracollinoides. In some embodiments, microbes have been removed from the composition. In some embodiments, the dry weight percentage of microbial biomass in the composition is below 0.001% in relation to the total dry weight of the composition. In some embodiments, the composition does not comprise microbes.

Also disclosed herein is a composition comprising one or more molecular species corresponding to one or more of peaks C, F, G, J, O, or P in the LC-MS chromatogram shown in FIG. 3. In some embodiments, the composition comprises one or more molecular species corresponding to one or more of peaks A, B, C, D, E, F, or G in the GC-MS chromatogram shown in FIG. 4. In some embodiments, the composition comprises one or more molecular species corresponding to one or more of peaks A, B, C, D, or E in the ¹H-NMR spectrum shown in FIG. 5. In some embodiments, the composition comprises one or more molecular species corresponding to one or more of peaks A or B in the ¹³C-NMR spectrum shown in FIG. 6. In some embodiments, the composition comprises xylose at a concentration of more than 15 mol % in relation to all glycosyl residues in the composition. In some embodiments, the composition comprises mannose at a concentration of more than 7 mol % in relation to all glycosyl residues in the composition. In some embodiments, the composition comprises one or more of isobutanol, pentadecanenitrile, pentadecanoic acid, 9-octadecenenitrile, hexadecanenitrile, or heneicosane. In some embodiments, the digestion products comprise the molecular species listed in FIG. 39.

In some embodiments, the composition further comprises microbes. In some embodiments, the microbes comprise sporulated microbes. In some embodiments, the dry weight percentage of microbial biomass in the composition is from 0.071 to 0.714% in relation to the total dry weight of the composition. In some embodiments, the microbes present in the composition comprise one or more of Microbacterium amylolyticum, Thermoanaerobacterium thermosaccharolyticum, Cellulosilyticum lentocellum, Microbulbifer thermotolerans, Collinsella sp., Acinetobacter spp., Acinetobacter towneri, Lentilactobacillus buchneri, Liquorilactobacillus hordei, or Secundilactobacillus paracollinoides. In some embodiments, the dry weight percentage of microbial biomass in the composition is below 0.001% in relation to the total dry weight of the composition. In some embodiments, the composition does not comprise microbes.

In some embodiments, the composition is a liquid composition. In some embodiments, the digestion products are present in the liquid composition at 0.06% to 0.08% by weight in relation to the total weight of the liquid composition.

Also disclosed is a plant treatment composition comprising any of the above compositions and a fertilizer composition. In some embodiments, the fertilizer composition is a liquid. In some embodiments, the fertilizer composition is a solid. In some embodiments, the fertilizer composition is coated by any of the biostimulant compositions described above.

Also disclosed is a method of promoting plant growth comprising contacting a plant, a seed of the plant, or a growth medium for the plant, with any of the above described compositions. In some embodiments, promoting plant growth comprises one or more of the following: enhancing seed germination, enhancing early plant development, improving root growth, increasing nutrient uptake, improving tolerance to abiotic stress, mitigating transplant shock, improving plant reproduction, and improving soil microbial activity. In some embodiments, improving tolerance to abiotic stress comprises improving one or more of the following: salt tolerance, heat tolerance, cold tolerance, and drought tolerance. In some embodiments, the contacting comprises in-furrow application, foliar spray application, or application to a rooting zone. In some embodiments, the contacting comprises applying 0.14 to 6.7 g by dry weight of the digestion products per acre.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings.

FIG. 1: GC-MS chromatogram of Ascophyllum nodosum powder feedstock (top chromatogram) and Ecklonia maxima powder feedstock (bottom chromatogram).

FIG. 2: Results of an analysis of glycosyl residue content in MBT-A and MBT-E products.

FIG. 3: LC-MS chromatograms of MBT-A (top) and MBT-E (bottom) products.

FIG. 4: GC-MS chromatograms of MBT-E (top) and MBT-A (bottom) products. Arrows point to unique peaks in MBT-E identified with Mass Hunter Quantitative software and qualitative software by Agilent Technologies (Palo Alto, CA, USA), based on a match factor>70% and areas>1×10⁵

FIG. 5: ¹H-NMR spectra of MBT-A (top) and MBT-E (bottom).

FIG. 6: ¹³C-NMR spectra of MBT-A (top) and MBT-E (bottom).

FIG. 7: Cotton leaf chlorophyll contents during drought stress conditions (SPAD1 and SPAD2 recorded on days 15 and 26 after drought stress water regiment started, respectively).

FIG. 8: Proline accumulation during drought stress conditions (proline concentrations were recorded on days 30 after drought stress water regimen started).

FIG. 9: Cotton plants height during drought stress conditions (plant height was recorded on days 90 after drought stress water regimen started).

FIG. 10: Cotton bolls production during drought stress conditions (boll counted on days 80 after drought stress water regimen started). The cotton bolls size measured in centimeters (cm) and bolls with a size of greater than or equal to 2 cm were not considered.

FIG. 11: Average cotton production of MBT-E treated plants and untreated control plants.

FIG. 12: Relative water content of corn leaf during drought stress conditions measured 26 days after drought stress water regimen started.

FIG. 13: Proline accumulation during drought stress conditions (proline concentrations were recorded on days 30 after drought stress water regimen started).

FIG. 14: Average corn ear length and weight measured just before harvest.

FIG. 15: Corn yield resulting from indicated treatments.

FIG. 16: Shoot surface area resulting from indicated treatments. Asterisks indicate statistically significant differences.

FIG. 17: Root surface area resulting from indicated treatments. Asterisks indicate statistical significance.

FIG. 18: Root length resulting from indicated treatments. Asterisks indicate statistical significance.

FIG. 19: Shoot surface area resulting from indicated treatments. Asterisks indicate statistical significance.

FIGS. 20A-C: (A) Growth rate under drought conditions resulting from indicated treatments. (B) Growth rate after recovery resulting from indicated treatments. (C) Growth rate resulting from indicated treatments. Asterisks indicate statistical significance.

FIG. 21: Leaf temperature resulting from indicated treatments. UTC=untreated control.

FIG. 22: Percent change in stomatal conductance at indicated times resulting from indicated treatments.

FIG. 23: Percent change in stomatal conductance at indicated times resulting from indicated treatments.

FIG. 24: Percent change in stomatal conductance at indicated times resulting from indicated treatments.

FIG. 25: Percent change in stomatal conductance at indicated times resulting from indicated treatments.

FIG. 26: Percent change in stomatal conductance at indicated times resulting from indicated treatments.

FIG. 27: Cotton leaf chlorophyll contents at the indicated times resulting from indicated treatments.

FIG. 28: Shoot surface area resulting from indicated treatments. Asterisks indicate statistical significance.

FIG. 29: Rating of plants resulting from indicated treatments. Asterisks indicate statistical significance.

FIG. 30: Fresh shoot weight resulting from indicated treatments. Asterisks indicate statistical significance.

FIG. 31: Shoot surface area and growth rates resulting from indicated treatments. Asterisks indicate statistical significance.

FIG. 32: Shoot surface area resulting from indicated treatments. Asterisks indicate statistical significance.

FIG. 33: Chlorophyll contents (SPAD) resulting from indicated treatments. Asterisks indicate statistical significance.

FIG. 34: Stem diameter resulting from indicated treatments.

FIGS. 35A-B: (A) Height at harvest resulting from indicated treatments. (B) Total biomass resulting from indicated treatments.

FIG. 36: Electrical conductivity at soil resulting from indicated treatments.

FIG. 37: Yield of bell peppers resulting from indicated treatments.

FIG. 38: Nutrient content resulting from indicated treatments.

FIG. 39: Unique peaks in MBT-E as compared to MBT-A GC-MS chromatogram.

FIG. 40: Bacterial community analysis on two seaweed feedstocks: Ecklonia maxima feedstock (EMF) and Ascophyllum nodosum feedstock (ANF). DNA was extracted from the powdered seaweed feedstock and the bacterial community was characterized through amplicon-sequencing of the small ribosomal RNA gene (i.e. 16S rRNA gene). Bacterial community profiles were displayed as a UPGMA cluster analysis tree.

FIG. 41: Bacterial community analysis on the seaweed product solutions MBT-E and MBT-A. DNA was extracted from concentrated product solutions (4×) and the bacterial community was characterized through amplicon-sequencing of the small ribosomal RNA gene (i.e. 16S rRNA gene). Bacterial community profiles were displayed as a UPGMA cluster analysis tree.

### DETAILED DESCRIPTION

Embodiments described herein include biostimulant compositions and methods for enhancing plant growth and increasing plant tolerance to abiotic stress including, for example, drought, cold, heat, and salt stress. Compositions include microbial digestion products produced by digestion of Ecklonia maxima kelp.

### I. Digestion Process

In some embodiments, a biostimulant composition is made by a process of digestion of an organic feedstock comprising Ecklonia maxima kelp. In some embodiments, the organic feedstock further comprises chitin and Saccharomyces cerevisiae yeast. The organic feedstock may be an aqueous slurry of powdered Ecklonia maxima kelp, chitin, and Saccharomyces yeast. In some embodiments, the digestion is anaerobic digestion. Without wishing to be bound by theory, it is believed that during the digestion process, microbes endogenous to the Ecklonia maxima kelp and chitin digest the biomolecules and other nutrients present in the kelp, chitin, and yeast and produce digestion products that include compounds that promote plant growth, abiotic stress tolerance, and soil health. The biostimulant may also contain microbes that contribute to the plant-beneficial properties of the biostimulant product. The microbes in the biostimulant product may be derived from the microbial population present in the kelp feedstock.

A digestion process to produce the biostimulant may be performed in a digestion system that includes a series of tanks through which the feedstock continuously flows. Fluid from the top of each tank may flow into the next tank continuously, and the rate of outflowing product may match the rate of inflowing feedstock, providing for a hydraulically balanced flow throughout the system. Each tank within the system may have a unique, stable microbial consortium with distinct physiological characteristics and digestion capabilities as compared to consortia in other tanks in the system.

In some embodiments of a digestion process, powdered Ecklonia maxima kelp, chitin, and Saccharomyces cerevisiae yeast may be mixed with water to make an organic feedstock for an anaerobic digestion system. The anaerobic digestion system may include a mixing tank in which the organic feedstock is mixed to make a homogenous slurry. The slurry may then be flowed in a continuous and hydraulically balanced manner through a series of 4 digestion tanks. More or fewer tanks may be used, and hydraulic flow rate may be changed to obtain a desired outcome. In the first digestion tank, the slurry may be agitated at a rate that allows heavier or undigested solids to settle to the bottom. An outlet at the top of the first digestion tank may allow the fluid to flow into the second digestion tank. An outlet at the bottom of the first digestion tank may transfer the settled solids back into the mixing tank. Each of the three digestion subsequent tanks, which may be referred to as packed-bed reactors, may have submerged fixed media substrates that provide a surface for biofilm growth. The flow rate of the digestion system may be chosen to allow for sufficient dwell time within each of the digestion tanks for a stable and unique microbial consortium to form within each of the digestion tanks. The microbes in the consortia may be derived from the microbes originally present within the organic feedstock. The microbes may digest the Ecklonia maxima kelp, chitin, and yeast to produce digestion products. The outflow from the top of the fourth digestion tank, may be used as a biostimulant to promote plant growth or improve soil quality, as described in more detail below.

In some embodiments, biostimulant compositions are made by a process described in U.S. App. Pub. No. 2013/0324406, which is hereby incorporated by reference in its entirety, using Ecklonia maxima, chitin, and Saccharomyces cerevisiae yeast as a feedstock.

Biostimulant compositions produced by a digestion process as described above may be used as-is or may be further processed before being used. For example, the outflow from the digestion system, referred to herein as “base product,” may be concentrated, sterilized, filtered, pasteurized, or dehydrated before being use, or any combination of these. In some embodiments, the base product may be concentrated 2×, 3×, 4×, 5×, 6×, 7×, 8×, 9×, 10×, or more. In some embodiments, the base product may be filter sterilized to remove any bacteria or other microbes in the composition.

Parameters of the digestion system, such as flow rate and the solids content of the organic feedstock, may be varied to achieve desired properties in the outflow biostimulant base product.

### II. Physical Properties and Composition of Biostimulant

Embodiments described herein include biostimulant compositions that include chemical species and/or microbes that promote plant growth, including by increasing plants' ability to tolerate abiotic stress such as cold, heat, drought, and salt. Biostimulant compositions described herein may include dead microorganisms, sporulated microorganisms, fragments of dead microorganisms, viable microorganisms, microorganism fermentation products, enzymes, biological plant growth regulators, organic acids, chelators, or a combination thereof.

Embodiments described herein also include biostimulant compositions that include digestion products produced by digestion of an organic feedstock comprising Ecklonia maxima kelp. The biostimulant may include metabolites produced by microbes endogenous to the organic feedstock, which microbes may be derived from kelp feedstock or from other components of the organic feedstock such as, for example, chitin. Such metabolites may include, for example, sugars and fatty acids. Digestion products may also include dead microorganisms, fragments of dead microorganisms, microorganism fermentation products, enzymes, biological plant growth regulators, organic acids, chelators, or a combination thereof.

Biostimulant compositions described herein may include one or more sugars. In some embodiments, the biostimulant composition may be characterized by the glycosyl residue content of the biostimulant composition. In some embodiments, the biostimulant composition may include one or more of rhamnose, fucose, xylose, mannose, or glucose, or any combination thereof. In some embodiments, the biostimulant composition does not include galactose or includes galactose at less than 1 mol % in comparison to other glycosyl residues present in the biostimulant composition. In some embodiments, the biostimulant composition comprises fucose at less than about or about 40, 30, 20 or 15 mol % in comparison to all other glycosyl residues present in the biostimulant composition. In some embodiments, the biostimulant composition comprises xylose at at least about or about 15, 20, 25, or 30 mol % in comparison to all other glycosyl residues present in the biostimulant composition. In some embodiments, the biostimulant composition comprises mannose at at least about or about 6, 8, 10, 12, 14, 16, 18, or 20 mol % in comparison to other glycosyl residues present in the biostimulant composition.

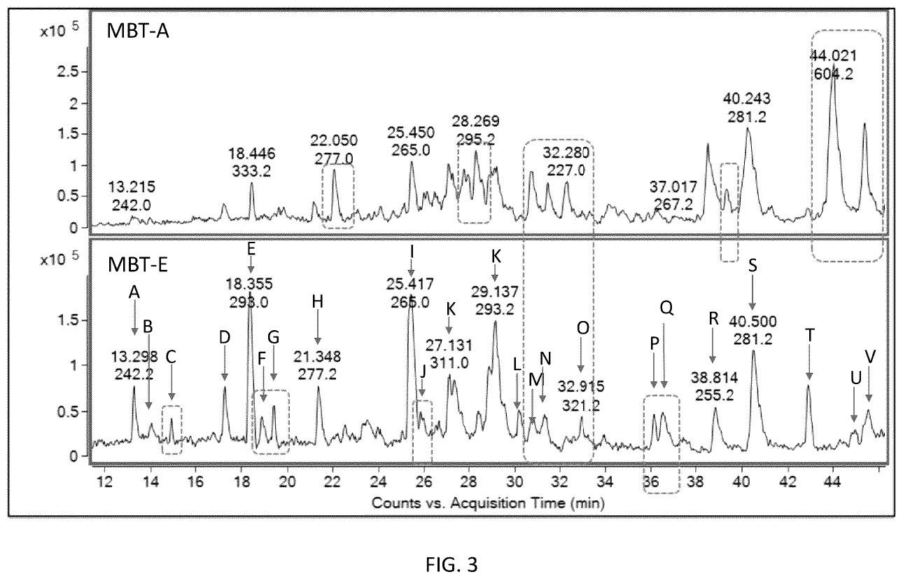

In some embodiments, biostimulant compositions described herein may be characterized by mass spectrometry or NMR spectroscopy. In some embodiments, the biostimulant composition has an LC-MS chromatogram as shown in the bottom panel of FIG. 3. In some embodiments, the biostimulant composition includes one or more molecular species corresponding to any of the one or more peaks in the LC-MS chromatogram as shown in the bottom panel of FIG. 3, or any combination of such molecular species. In some embodiments, the biostimulant composition comprises a molecular species corresponding to the peak labeled A, B, C, D, E, F, G, H, I, J, K, L, M, N, O, P, Q, R, S, T, U, or V in the LC-MS chromatogram shown in the bottom panel of FIG. 3, or any combination of such molecular species. In some embodiments, the biostimulant composition comprises one or more molecular species corresponding to one or more peaks in the LC-MS chromatogram shown in the bottom panel of FIG. 3 that are not present in the LC-MS chromatogram shown in the top panel of FIG. 3. In some embodiments, the biostimulant composition comprises a molecular species corresponding to the peak labeled C, F, G, J, M, N, O, P, or Q, or any combination of such molecular species. In some embodiments, the biostimulant composition does not comprise a molecular species corresponding to a peak that is present in the LC-MS chromatogram shown in the top panel of FIG. 3 that is absent from the LC-MS chromatogram shown in the bottom panel of FIG. 3.

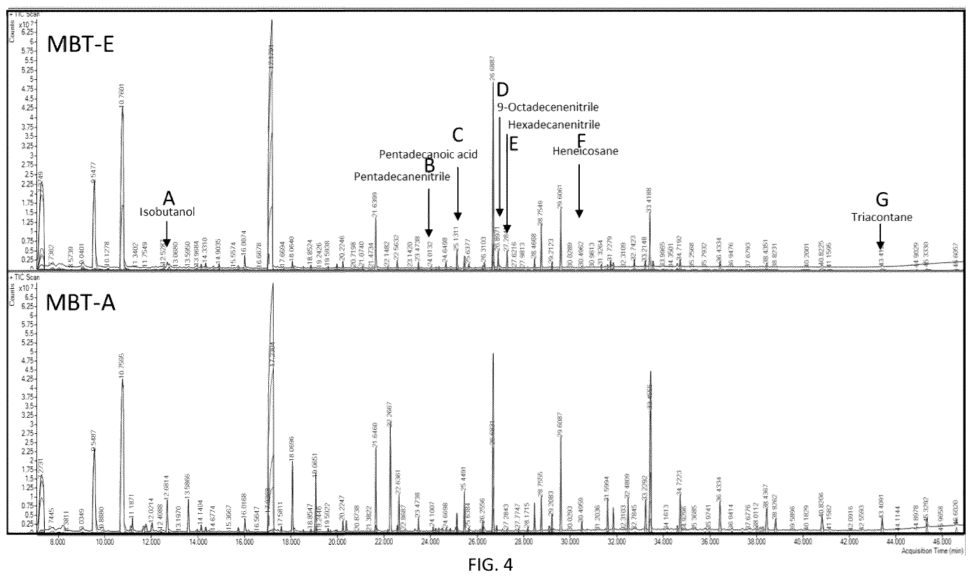

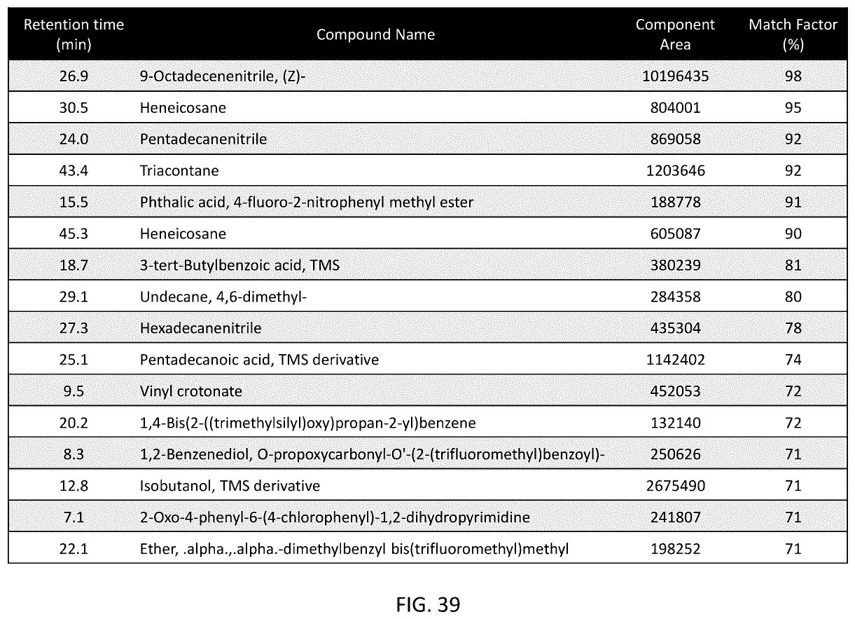

In some embodiments, the biostimulant composition has a GC-MS chromatogram as shown in the top panel of FIG. 4. In some embodiments, the biostimulant composition includes one or more molecular species corresponding to any of the one or more peaks in the GC-MS chromatogram as shown in the top panel of FIG. 4, or any combination of such molecular species. In some embodiments, the biostimulant composition comprises a molecular species corresponding to the peak labeled A, B, C, D, E, F, or G in the GC-MS chromatogram shown in the top panel of FIG. 4, or any combination of such molecular species. In some embodiments, the biostimulant composition comprises one or more molecular species corresponding to one or more peaks in the GC-MS chromatogram shown in the top panel of FIG. 4 that are not present in the GC-MS chromatogram shown in the bottom panel of FIG. 4. In some embodiments, the biostimulant composition does not comprise a molecular species corresponding to a peak that is present in the GC-MS chromatogram shown in the bottom panel of FIG. 4 that is absent from the GC-MS chromatogram shown in the top panel of FIG. 4. In some embodiments, the biostimulant composition comprises one or more molecular species listed in FIG. 39, or any combination of such molecular species.

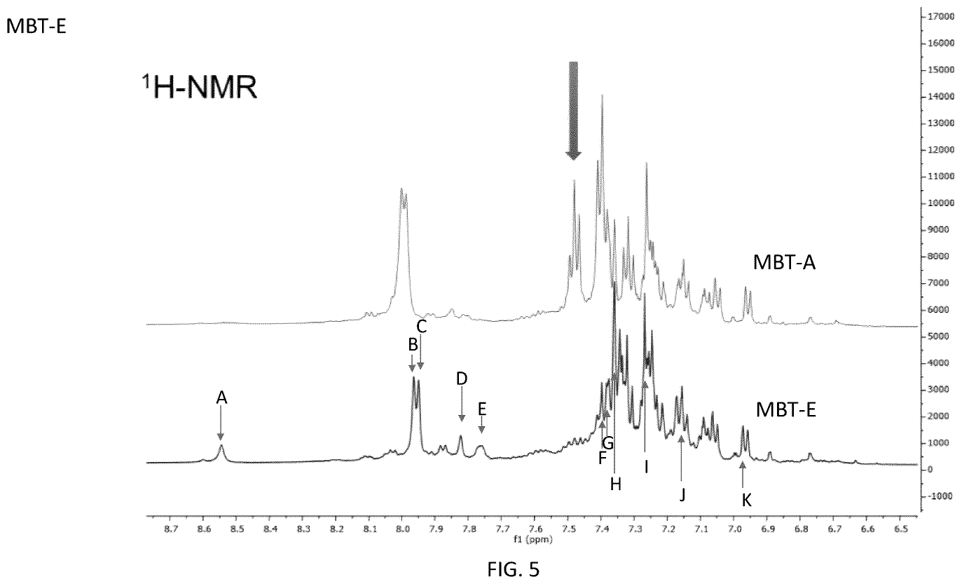

In some embodiments, the biostimulant composition has an ¹H-NMR spectrum as shown in the bottom spectrum of FIG. 5. In some embodiments, the biostimulant composition includes one or more molecular species corresponding to any of the one or more peaks in the bottom ¹H-NMR spectrum of FIG. 5, or any combination of such molecular species. In some embodiments, the biostimulant composition comprises a molecular species corresponding to the peak labeled A, B, C, D, E, F, G, H, I, J, or K in the bottom ¹H-NMR spectrum of FIG. 5, or any combination of such molecular species. In some embodiments, the biostimulant composition comprises one or more molecular species corresponding to one or more peaks in the bottom ¹H-NMR spectrum of FIG. 5 that are not present in the top ¹H-NMR spectrum of FIG. 5. In some embodiments, the biostimulant composition comprises a molecular species corresponding to the peak labeled A, C, D, or E, in FIG. 5 or any combination of such molecular species. In some embodiments, the biostimulant composition does not comprise a molecular species corresponding to a peak that is present in the top ¹H-NMR spectrum of FIG. 5 that is absent from the bottom ¹H-NMR spectrum of FIG. 5.

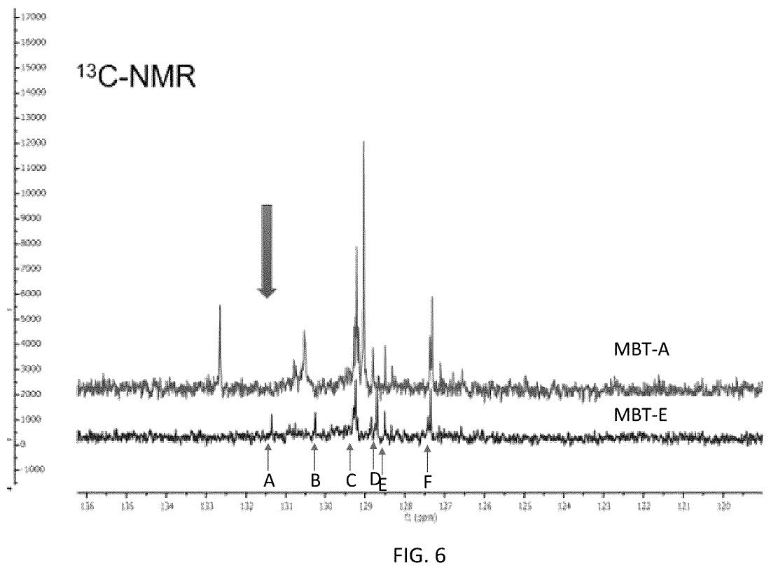

In some embodiments, the biostimulant composition has an ¹³C-NMR spectrum as shown in the bottom spectrum of FIG. 6. In some embodiments, the biostimulant composition includes one or more molecular species corresponding to any of the one or more peaks in the bottom ¹³C-NMR spectrum of FIG. 6, or any combination of such molecular species. In some embodiments, the biostimulant composition comprises a molecular species corresponding to the peak labeled A, B, C, D, E, or F in the bottom ¹³C-NMR spectrum of FIG. 6, or any combination of such molecular species. In some embodiments, the biostimulant composition comprises one or more molecular species corresponding to one or more peaks in the bottom ¹³C-NMR spectrum of FIG. 6 that are not present in the top ¹³C-NMR spectrum of FIG. 6. In some embodiments, the biostimulant composition comprises a molecular species corresponding to the peak labeled A or B in FIG. 6 or any combination of such molecular species. In some embodiments, the biostimulant composition does not comprise a molecular species corresponding to a peak that is present in the top ¹³C-NMR spectrum of FIG. 6 that is absent from the bottom ¹³C-NMR spectrum of FIG. 6.

In some embodiments, biostimulant compositions include viable microbes. In some embodiments, the microbes include bacteria that are derived from the bacterial population present in the Ecklonia maxima kelp feedstock. The bacteria may include one or more bacteria listed in Table 1. In some embodiments, the biostimulant includes one or more bacterial species that is not found in a product derived from microbial digestion products of other kelp species, such as Ascophyllum nodulum. In some embodiments, the biostimulant includes Microbacterium amylolyticum, Thermoanaerobacterium thermosaccharolyticum, Cellulosilyticum lentocellum, Microbulbifer thermotolerans, Collinsella sp., Acinetobacter spp., Acinetobacter towneri, Lentilactobacillus buchneri, Liquorilactobacillus hordei, or Secundilactobacillus paracollinoides, or any combination thereof. In some embodiments, any one of these bacterial species comprises at least 0.00001, 0.00005, 0.0001, 0.0005, 0.001, 0.0015, or 0.002% of the bacterial species present in the biostimulant, as determined by metagenomic sequencing.

In some embodiments, the biostimulant is filter sterilized and does not comprise viable microbes. In some embodiments, the dry weight of the microbial biomass is less than 0.0001% in relation to the total dry weight of the composition.

In some embodiments, the biostimulant comprises from 0.05 to 0.8% dry weight of microbial biomass in relation to the total dry weight of the biostimulant composition. In some embodiments, the dry weight percentage is at least about, at most about, or about 0.05, 0.1, 0.2, 0.3, 0.4, 0.5, 0.6, 0.7, or 0.8%, or a range between any two of these values.

In some embodiments, the biostimulant comprises from 100 to 5×10⁵ CFU/ml of bacteria. In some embodiments, the biostimulant comprises at least about, at most about, or about 100, 500, 1×10³, 5×10³, 1×10⁴, 5×10⁴, or 1×10⁵ CFU/ml of bacteria, or a range between any two of these values.

In some embodiments, the biostimulant has a pH of from 7.5 to 8.5. In some embodiments, the electrical conductivity of the biostimulant is about 900, 950, 1000, 1050, or 1100 μS/cm. In some embodiments, the density of the biostimulant is about 0.997 to 0.999 g/cm³ or is about 0.998 g/cm³. In some embodiments, the biostimulant has a solids content of 0.01 to 2%. In some embodiments, the solids content is about 0.01, 0.05, 0.1, 0.15, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0, or a range between any two of these values. In some embodiments, the chemical oxygen demand (COD) of the biostimulant is from 10 to 200 mg/L. In some embodiments, the COD is 10, 20, 30, 40, 50, 100, 125, 150, 175, or 200 mg/L, or is between any two of these values. Conductivity and COD values will vary with the concentration rate of the biostimulant, and will increase as concentration increases.

### III. Methods of Use

Embodiments of biostimulant compositions may be used in methods of promoting plant growth for a variety of different plants and conditions. In some embodiments, contacting a plant, seed, or growth medium with the biostimulant promotes plant growth by, for example, increasing growth rate, yield at harvest, production, stem thickness, fruit abundance and/or size, grain production, leaf surface area, root surface area, root length, root depth, shoot thickness, or total mass, as compared to a plant that has not received the treatment. In some embodiments, promoting plant growth comprises one or more of enhancing seed germination, enhancing early plant development, increasing nutrient uptake, mitigating transplant shock, improving plant reproduction, and improving soil microbial activity. In some embodiments, any one or more of these plant qualities are increased by at least 5, 10, 15, 20, 25, 30, 35, 40, 45, or 50% or more, as compared to the same plant that has not received the treatment. In some embodiments, contacting a plant, seed, or growth medium with the biostimulant promotes plant growth by, for example, increasing a plant's tolerance to abiotic stress. Such abiotic stress may include drought stress, heat stress, cold stress, or stress from high salt concentrations. In some embodiments, increasing tolerance to one or more abiotic stresses leads to increased growth rate, yield at harvest, production, stem thickness, fruit abundance and/or size, grain production, leaf surface area, root surface area, root length, root depth, shoot thickness, or total mass as compared to the same plant under similar stress conditions that has not received the treatment. In some embodiments, treatment with the biostimulant promotes plant growth by increasing the plant's ability to recover from abiotic stress faster than it otherwise would without the treatment.

In some embodiments, a plant or growth medium is contacted with the biostimulant composition before, during, or after abiotic stress. For instance, a treatment with the biostimulant before abiotic stress may in some embodiments enable the plant to endure the abiotic stress better than a similar plant that has not received the treatment. In some embodiments, plant or growth medium is contacted with the biostimulant when the plant is at risk of experiencing abiotic stress, but before the abiotic stress has happened. The plant may be determined to be at risk of abiotic stress based on, for example, weather patterns or forecasts for the location in which the plant is growing. In some embodiments, a treatment to help relieve cold stress may be applied during a time of year in which frosts are more likely to happen, such as early spring or late fall, depending on the geographic location of the plant. In some embodiments, a treatment to help relieve heat or drought stress may be applied in late summer, when the plant is at risk of experiencing relatively high temperatures.

Persons of skill in the art will be able to ascertain a plant's relative risk for certain abiotic stresses based on the type of plant, the geographic location of the plant, and the local weather patterns and forecasts at the location.

In some embodiments, the biostimulant is applied to the plant while it is experiencing abiotic stress. Whether a plant is experiencing abiotic stress may be ascertained by those skilled in the art based on the type of plant and the particular circumstances in which the plant is growing. For instance, drought stress may be determined based on observation of soil moisture content and the condition of the plant. As some species and varieties of plants are innately more tolerant to drought than others, soil and air humidity conditions that stress one species or variety may not stress another species or variety. The same applies to other potential stresses, such as heat, cold, and salt stresses.

In some embodiments, the biostimulant is applied when a plant has experienced, is experiencing, or is expected to experience, temperatures at or below about 15, 10, 5 or 0° C. In some embodiments, the biostimulant is applied when a plant has experienced, is experiencing, or is expected to experience temperatures at or above about 20, 25, 30, 35, or 40° C. In some embodiments, the biostimulant is applied when a plant has experienced, is experiencing, or is expected to experience a moisture content of soil below about 30, 25, 20, 15, 10, 5, or 1% for a duration of at least about 6, 12, 24, or 48 hours or 3, 4, 5, 6, 7, 8, 9, or 10 days.

In some embodiments, the biostimulant is applied within 12, 24, 36, or 48 hours, or 3, 4, 5, 6, 7, 8, 9, or 10 days of when the plant has experienced or is expected to experience the abiotic stress. In some embodiments, the biostimulant is applied when the probability of the plant experiencing abiotic stress within 12, 24, 36, or 48 hours, or 3, 4, 5, 6, 7, 8, 9, or 10 days after the application is determined to be at least about 30, 40, 50, 60, 70, 80, or 90%.

In some embodiments, the biostimulant is applied when no abiotic stress has been experienced or is expected to be experienced. In addition to increasing tolerance for abiotic stress, embodiments of biostimulant compositions disclosed herein can promote plant growth in the absence of abiotic stress.

In some embodiments, the biostimulant is applied to the plant or growth medium before transplanting the plant. In some embodiments, the biostimulant is applied to the plant or growth medium after transplanting the plant. In some embodiments, the biostimulant is applied to the plant or growth medium while the plant is being transplanted. In some embodiments, the biostimulant is applied to a growth medium (e.g., soil) into which the plant is to be transplanted.

In some embodiments, the plant treated with the biostimulant composition may be, for example, crops, vegetables, flowers, foliage plants, turf grasses, trees, shrubs, and the like. Non-limiting examples of crops include corn, rice, wheat, barley, rye, oat, sorghum, cotton, soybean, peanut, buckwheat, beet, rapeseed, sunflower, sugar cane, marijuana, and tobacco. Non-limiting examples of vegetables include solanaceous vegetables (eggplant, tomato, pimento, pepper, potato, etc.), cucurbitaceous vegetables (cucumber, pumpkin, zucchini, watermelon, melon, squash, etc.), cruciferous vegetables (Japanese radish, white turnip, horseradish, kohlrabi, Chinese cabbage, cabbage, leaf mustard, broccoli, cauliflower, etc.), asteraceous vegetables (burdock, crown daisy, artichoke, lettuce, etc.), liliaceous vegetables (green onion, onion, garlic, and asparagus), ammiaceous vegetables (carrot, parsley, celery, parsnip, etc.), chenopodiaceous vegetables (spinach, Swiss chard, etc.), lamiaceous vegetables (Perilla frutescens, mint, basil, etc.), strawberry, sweet potato, Dioscorea japonica, and colocasia. Non-limiting examples of fruits include pomaceous fruits (apple, pear, Japanese pear, Chinese quince, quince, etc.), stone fleshy fruits (peach, plum, nectarine, Prunus mume, cherry fruit, apricot, prune, etc.), citrus fruits (Citrus unshiu, orange, lemon, rime, grapefruit, etc.), nuts (chestnuts, walnuts, hazelnuts, almond, pistachio, cashew nuts, macadamia nuts, etc.), berries (blueberry, cranberry, blackberry, raspberry, etc.), grape, kaki fruit, olive, Japanese plum, banana, coffee, date palm, and coconuts. Non-limiting examples of trees include fruit trees, tea, mulberry, flowering plant, and roadside trees (ash, birch, dogwood, Eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate). The term “plant” or “plants” refers to both native and genetically engineered plants. In some embodiments, the biostimulant is applied to a seed of any of the plants described above.

In certain embodiments, biostimulant compositions described herein are applied to soil, applied to fertilizer used to fertilize plants, applied directly to plants, or applied to both soil and plants. Compositions may also be applied directly to a plant seed. In addition to soil, biostimulant compositions may be applied to other plant growth media such as, for example, a hydroponic growth medium. Compositions may be used in in-furrow applications, foliar applications, or both. In some embodiments, the biostimulant composition is applied on its own. When applied on its own, in some embodiments, the composition is applied before or after application of a conventional fertilizer and/or pesticide. When applied before or after application of a conventional fertilizer and/or pesticide, the composition is applied sufficiently close in time to the conventional fertilizer and/or pesticide so that the formulation may have its desired effect of enhancing the effect of the conventional fertilizer and/or pesticide. In some embodiments, the composition is applied in conjunction with a conventional fertilizer and/or pesticide. The composition may either be mixed with a conventional fertilizer and/or pesticide or applied simultaneously with a conventional fertilizer and/or pesticide.

In some embodiments, the biostimulant compositions described herein are mixed with a conventional fertilizer or pesticide at a ratio of about 3:1 to about 1:100 biostimulant to conventional fertilizer or pesticide. In some embodiments, biostimulant compositions are mixed with a conventional fertilizer or pesticide in a ratio of about 1:20 biostimulant to conventional fertilizer or pesticide. Biostimulant compositions described herein may also be coated on particles of conventional fertilizer or pesticide. Particles of fertilizer or pesticide may be coated by, for example, spray drying the biostimulant onto the surface of the fertilizer or by mixing a dehydrated powder form of the biostimulant with the particles, with or without a binder or carrier.

In certain embodiments, the conventional fertilizer is a starter fertilizer. In some embodiments, the conventional fertilizer includes at least one of ammonia, urea, ammonium nitrate, ammonium sulfate, ammonium thiosulfate, monoammonium phosphate (MAP), diammonium phosphate (DAP), muriate of potash (MOP), sulfate of Potash (SOP), potassium nitrate (NOP). In some embodiments, the starter fertilizer is a 10-34-0 starter fertilizer.

In certain embodiments, the biostimulant compositions described herein are applied to soil or plants in an amount of about 0.5 to about 10 quarts per acre. In some embodiments, the formulations are applied in an amount of about 4 quarts per acre. In some embodiments, the biostimulant composition is applied in an amount of about 0.5, 1, 2, 3, 4, 5, 6, 7, 8, 9, or 10 quarts per acre. In some embodiments, the amount of biostimulant composition applied is characterized by the dry weight of substances present in the biostimulant composition applied. The dry weight of a given volume of liquid biostimulant composition is the weight of all substances in the volume of biostimulant other than water. In some embodiments, an amount of biostimulant is applied that provides for 0.10 to 10 g by dry weight of digestion products to be applied per acre. In some embodiments, the amount of biostimulant applied provides for at least about, at most about, or about 0.1, 0.5, 1, 2, 3, 4, 5, 6, 7, 8, 9, or 10 g by dry weight of digestion products per acre, or a range within any two of these values. In some embodiments, the amount of biostimulant applied provides for at least about, at most about, or about 0.1, 0.5, 1, 2, 3, 4, 5, 6, 7, 8, 9, or 10 g by dry weight of biostimulant components to be applied, or a range between any two of these values. The amount of biostimulant composition applied may also be characterized in terms of the numbers of colony forming units of bacteria applied. In some embodiments, the amount of biostimulant applied provides for at least about, at most about, or about 5×10³, 1×10⁴, 5×10⁴, 1×10⁵, 5×10⁵, 1×10⁶, or 5×10⁶ CFU of bacteria to be applied per acre, or a range between any two of these values.

In some embodiments, biostimulant compositions described herein may be applied in dry form. A biostimulant base product may be dehydrated to make a powdered product that is applied to a growth medium (e.g., soil), to a plant, or to a seed.

In some embodiments, the amount of biostimulant applied is an effective amount to achieve a desired plant growth promoting effect. For instance, an effective amount of a biostimulant base product, such as the MBT-E product described in the Examples below, to increase cotton plant height in comparison to untreated plants is 0.5 or 1 quarts per acre (qt./A). In some embodiments, the biostimulant composition is applied in an effective amount to increase a plant's tolerance to drought, salt, heat, or cold stresses, or to achieve any other desirable outcome described herein that the biostimulant composition is capable of achieving.

The compositions comprising a biostimulant composition and other components described herein (e.g., a fertilizer) can be formed by mixing the components in a tank (i.e., tank mix). Following mixing, formulations can be bottled or otherwise packaged (e.g., in drums), applied to a field or crop, or mixed with other components. When bottled or otherwise packaged, the end user can mix the formulation with other components prior to application. The biostimulant composition can be mixed with conventional fertilizer by tank mixing, including splash mixing with minimal further mixing, or can be blended into the conventional fertilizer.

In some embodiments, the biostimulant is applied only once. In some embodiments, a single application is sufficient to promote plant growth as described herein. In some embodiments, a biostimulant composition is applied 1, 2, 3, 4, or 5 times during a growing season. In some embodiments, applications are 1, 2, 3, 4, 5, or 6 weeks apart.

### IV. Certain Definitions

In the above description, certain specific details are set forth in order to provide a thorough understanding of various embodiments. However, one skilled in the art will understand that the embodiments provided may be practiced without these details. Unless the context requires otherwise, throughout the specification and claims which follow, the word “comprise” and variations thereof, such as, “comprises” and “comprising” are to be construed in an open, inclusive sense, that is, as “including, but not limited to.” As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. Further, headings provided herein are for convenience only and do not interpret the scope or meaning of the claimed embodiments.

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviation, per the practice in the given value. Where particular values are described in the application and claims, unless otherwise stated the term “about” should be assumed to mean an acceptable error range for the particular value.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Microbial Digestion of Ecklonia maxima Kelp and Characterization of Digestion Products

Powdered Ecklonia maxima kelp, chitin, and Saccharomyces cerevisiae yeast were mixed with water to make an organic feedstock for an anaerobic digestion system. The anaerobic digestion system included a first tank in which the organic feedstock was mixed to make a homogenous slurry. The slurry was then flowed in a continuous and hydraulically balanced manner through a series of 4 digestion tanks. In the first digestion tank, the slurry was agitated at a rate that allowed heavier or undigested solids to settle to the bottom. An outlet at the top of the first digestion tank flowed the fluid into the second digestion tank. An outlet at the bottom of the first digestion tank flowed the settled solids back into the first tank. Each of the three subsequent tanks, referred to as packed-bed reactors, had submerged fixed media substrates that provided a surface for biofilm growth. The flow rate of the digestion system allowed for sufficient dwell time within each of the digestion tanks for a stable and unique microbial consortium to form within each of the digestion tanks. The microbes in the consortia were derived from the microbes originally present within the organic feedstock. The microbes digested the Ecklonia maxima kelp, chitin, and yeast to produce digestion products. The outflow from the top of the fourth digestion tank, referred to herein as MBT-E base product (BP), was a clear liquid with a light tan tint.

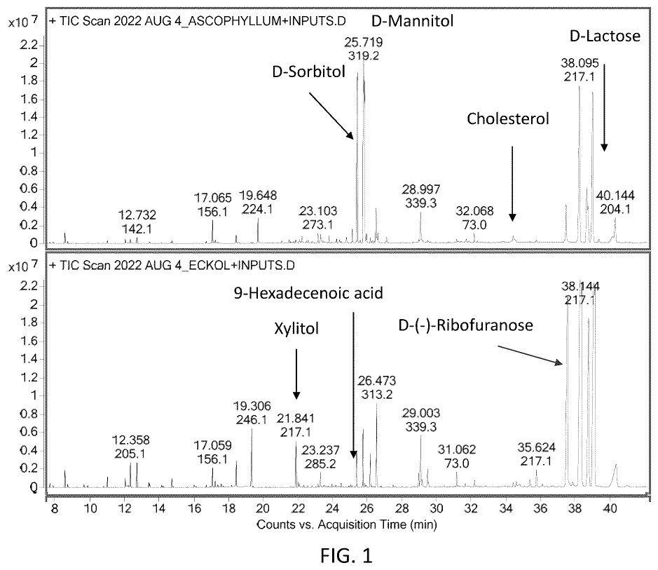

The Ecklonia maxima powder used as feedstock was evaluated by GC-MS and compared to an Ascophyllum nodosum powder used as a feedstock for the commercial product sold as Maritime™ by Loveland Agri Products (also referred to herein as MBT-A). The GC-MS chromatogram is shown in FIG. 1, with the top chromatogram coming from Ascophyllum nodosum, and the bottom chromatogram coming from Ecklonia maxima. The respective chromatograms each have unique peaks, as indicated by the arrows. The chromatograms also indicate that the two kelp feeds have different relative abundances of chemical species that they have in common.

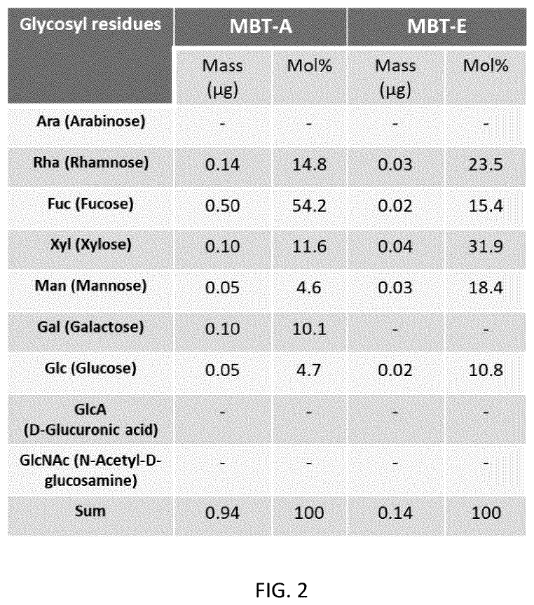

The chemical makeup of Maritime™ BP (MBT-A) and MBT-E BP were also analyzed and compared. The sugar residues present in the base products were analyzed by GC-MS of the per-O-trimethylsilyl (TMS) derivatives of the monosaccharide methyl glycosides generated from the samples by HCl methanolysis as described previously by Santander et al. (2013) Microbiology 159:1471. Inositol was added to each sample as internal standard. After lyophilization and derivatization, the samples were extracted with hexane for GC-MS analysis of the TMS methyl glycosides using an Agilent 7890A GC interfaced to a 5975C MSD, equipped with a Supelco Equity-1 fused silica capillary column (30 m×0.25 mm ID). The results are shown in FIG. 2. LC-MS chromatograms of the two base products are shown in FIG. 3, with MBT-A on the top and MBT-E on the bottom.

Dichloromethane extracts of MBT-A and MBT-E were analyzed by GC-MS according to the following procedure: 0.25 L of each sample were extracted with CH₂Cl₂ (0.25 L×2 times) and a mixture of CH₂Cl₂:MeOH (2:1) (0.25 L×2 times). The solvent extracts were filtered and dried under vacuo to afford a dried material. To compare chemical profiles of different batches, GC-MS analysis were performed. Samples were derivatized using N, O-bis(trimethylsilyl)trifluoroacetamide (BSTFA)+1% TMCS and Palmitic acid-¹³C₁₄ was used as an internal standard. GC-MS analyses were performed with an Agilent (Palo Alto, CA, USA) 8890 Series GC system equipped with a CTC-Pal injector and a 5977B Network Mass Selective Detector and a DB-1MS column (J&W, Palo Alto, CA, USA) (60 m×0.25 mm i.d., 0.25 um film thickness). Data acquisition and analysis was done using Agilent Mass Hunter Quantitative and qualitative software by Agilent Technologies (Palo Alto, CA, USA). The GC-MS chromatograms for MBT-A and MBT-E are shown in FIG. 4, with unique peaks identified with arrows. FIG. 39 lists molecular species that were found only in MBT-E. These were identified with Mass Hunter Quantitative software and qualitative software by Agilent Technologies (Palo Alto, CA, USA), based on a match factor>70% and areas>1×10⁵.

Methanol extracts of the base products were analyzed by ¹H-NMR and ¹³C-NMR, the spectra of which are shown in FIG. 5 and FIG. 6, respectively. Arrows indicate selected unique peaks.

MBT-E base product was treated by reverse osmosis to create 4× and 8× concentrated versions of MBT-E.

Bacteria present in the Ecklonia maxima feedstock and MBT-E base product were identified by 16S rRNA sequencing. Table 1 below shows the bacteria that were present in both the feedstock and the MBT-E product.

TABLE 1
Bacteria identified in Ecklonia maxima feedstock and MBT-E product

| Taxonomy | Genus | Species |
|---|---|---|
| hoeflea sp. jc234 | Actinotalea | |
| delta proteobacterium babl1 | Agrobacterium | agrobacterium vitis |
| gu178812.1 rhodococcus zopfii str. yq_1 | Dinoroseobacter | dinoroseobacter |
| | | shibae |
| conexibacter sp. bs10 | Frigoribacterium | |
| sphingobacterium sp. gr16 | Fucophilus | fucophilus |
| | | fucoidanolyticus |
| flavisolibacter sp. mdt2_37 | Halomonas | halomonas venusta |
| syntrophorhabdus aromaticivorans | Hoeflea | |
| eu000236.1 psychromonas arctica str. | Ketogulonicigenium | ketogulonicigenium |
| kopri_22215 | | vulgare |
| bacillus sp. sge 135(2010) | Loktanella | |
| dyadobacter sp. b2 | Luteimonas | |
| eubacterium sp. pei061 | Oceanicola | |
| ay543020.1 brochothrix thermosphacta mf 154 | Octadecabacter | |
| sphingopyxis sp. pr52_21 | Opitutus | |
| candidatus odyssella thessalonicensis | Ornithinimicrobium | |
| cytophaga sp. prpr22 | Paracoccus | paracoccus yeei |
| nr_028663.1 rhizobium yanglingense str. sh22623 | Phaeobacter | phaeobacter |
| | | gallaeciensis |
| eu730969.1 single_species ecosystem deep within | Pseudomonas | pseudomonas luteola |
| earth fracture water borehole mp104 level 104 2.8 | | |
| km depth clone sgnx0254 | | |
| x84808.1 leptolyngbya foveolarum str. komarek | Rhodobacter | rhodobacter spp. |
| 1964/112 | | |
| chitinophaga pinensis | Roseobacter | |
| ectothiorhodospira sp. ja741 | Salinibacterium | |
| eu256444.1 mesorhizobium loti str. ccbau 85072 | Serinicoccus | |

Metagenomic sequencing was performed to identify sporulated bacteria in the MBT-E product. Sporulated bacterial content by metagenomic sequencing constituted approximately 0.7% of the total population (1×10²-3×10³ CFU/ml based on percentage of total bacterial counts). The operational taxonomic units of sporulated bacteria include Bacillus spp., Aneurinibacillus thermoaerophilus, Virgibacillus spp. (including V. phasianinus and V. dokdonensis), Psychrobacillus sp., and Paenibacillus sphorae.

Bacteria identified by metagenomic sequencing in the MBT-E product were compared to those present in MBT-A/Maritime™. The following list includes members of the MBT-E community that are present in statistically significantly higher quantities than in the MBT-A product. The percentages listed represent the percentage of the total population present in MBT-E, and the “x” number listed represents how many times higher the population of the microbe is in MBT-E vs. MBT-A.
Saccharolytic and cellulosic communities: Microbacterium amylolyticum (0.0018%), Thermoanaerobacterium thermosaccharolyticum (0.0002%), Cellulosilyticum lentocellum (0.00005%), Microbulbifer thermotolerans (0.0015%, 1.38×) a genus that can also degrade complex carbohydrates such as cellulose, alginate, and chitin.
Collinsella sp. (0.00003%, 2.19×): A genus that can degrade bile acids (e.g. cholic acid) to secondary bile acids through the production of an NADPH-dependent 7β-hydroxysteroid dehydrogenase.
Acinetobacter spp. (0.00043%, 2.6×), including A. towneri, are aromatic compound degraders, allows iron and zinc solubilization and nutrient release through siderophore production, contain fungal suppressing genes, and contributes to pathogen suppressant soils.
Several non-spore forming lactic acid bacteria (LAB) communities include Lentilactobacillus buchneri (0.00005%, 2.41×), Liquorilactobacillus hordei (0.000023%, 4.01×), and Secundilactobacillus paracollinoides (0.00013%, 1.83×).

The 4× concentrated MBT-E also had the following properties: Light yellow liquid with a pH range of 7.5-8.5, Electrical conductivity 900-1100 (uS/cm), Density 0.998 (g/cm3), Solids content 0.07%, Viscosity 1.29 (cP), COD 20-150 (mg/L), total bacterial counts in a range of 5.0×10⁴ to 5.0×10⁵ CFU/ml and spore former counts 2×10² to 3×10³ CFU/ml.

### Example 2: Plant Growth Promoting Properties of MBT-E

Two experiments were conducted using a city of Denton soil (compost biosolids) and Whitesboro soil for drought stress alleviation in corn and cotton in a rainout shelter. The corn and cotton plants were thinned based on their uniform growth after the germination.

### Materials & Methods

Plant physiological traits: Plant physiological traits such as the stomatal conductance (gsw), transpiration rate (E), chlorophyll a fluorescence/quantum yield (QY), electron transport rate (ETR), and leaf temperature (T) were measured using a LICOR 600 Porometer/Fluorometer Portable Photosynthesis System (Li-Cor, Inc. Lincoln, NE, USA) after the drought stress water regimen initiated and irrigated the pots up to 20-30% soil moisture capacity. The ambient leaf temperature was measured as follows: Ambient leaf temperature (T_{amb})=T_{leaf}−T_{ref}. On days 15 and 26 after drought stress water regiment started, plant physiological parameters were measured between 11:00 and 15:00 on fully expanded cotton leaf of each plant. On days 7, 17, 26, and 32 after drought stress water regiment started, plant physiological parameters were measured between 11:00 and 15:00 on fully expanded corn leaf of each plant.

Leaf chlorophyll contents: The leaf chlorophyll contents were measured from a fully expanded leaf using a Chlorophyll Meter, SPAD (Soil Plant Analysis Development-502, Konica Minolta, Tokyo, Japan). The middle leaf position of leaf was selected for measuring the leaf chlorophyll contents to prevent the variation.

Proline assays: The extraction and determination of proline assays were conducted to determine the proline production on the leaf during the drought stress period using a method described by Carillo and Yves, PROTOCOL: Extraction and determination of proline (2011). The proline assays were conducted on 30 days after drought stress water regimen initiated. The leaf disc was collected, measured, and homogenized in 100% ethanol as an extract (e.g., 0.015 g/0.5 mL). The standards known as proline solutions were prepared ranging from 0.01 to 0.1 mM in 100% ethanol. The reaction mix was prepared using a 1% (w/v) ninhydrin in 60% (v/v) acetic acid and 20% ethanol. The combined mixture was transferred to 96-well plate, heated at 95° C. in a water bath for 20 minutes, and cooled to room temperature. The 96-well plate was read at 520 nm in the plate reader.

Relative water content (RWC): To determine the leaf relative water content, the fresh full expanded leaves were collected and measured using the following equation described by Teulat et al., QTL for relative water content in field-grown barley and their stability across Mediterranean environments. Theor. Appl. Genet. 2003, 108:181-188 (2003). RWC (%)=(Fresh weight−Dry weight)/(Completely turgid weight−Dry weight)×100

Statistical analyses and experimental design: In the rainout shelter tests, pots were arranged in a randomized complete block design (RCBD) with six treatments and 20 replications for corn experiment and eight treatments and 20 replications for cotton experiments, with each replication being a single plant in a single pot. The data of plant physiological parameters, leaf chlorophyll contents, proline assays, biomass, and the meta-analysis were analyzed with JMP 16 software (SAS Institute, Cary, NC, USA) using the Fit model at the p<0.1 level of significance.

### Results

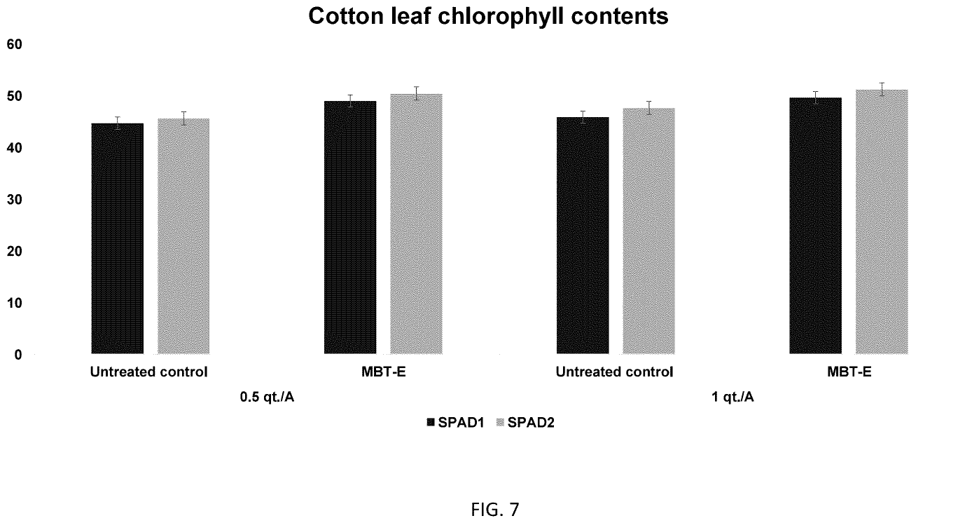

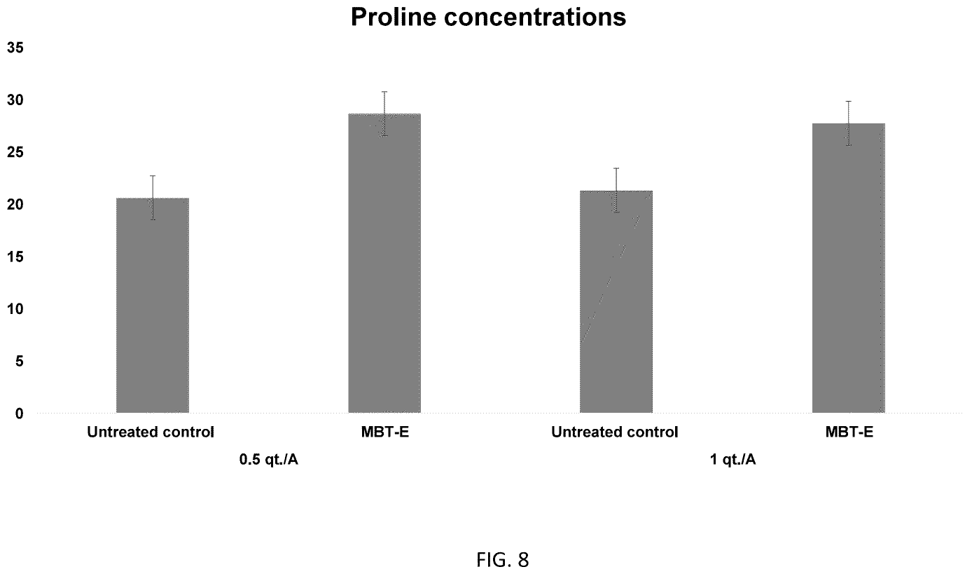

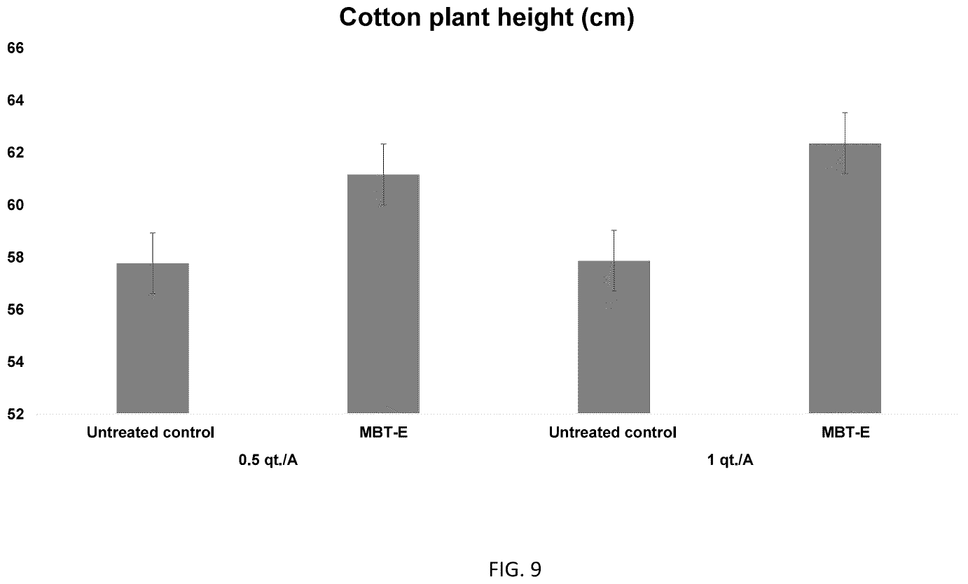

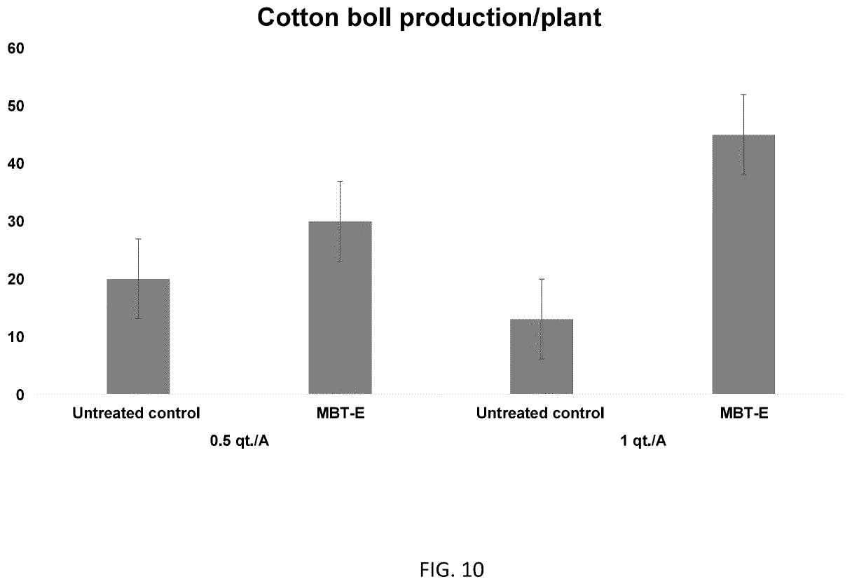

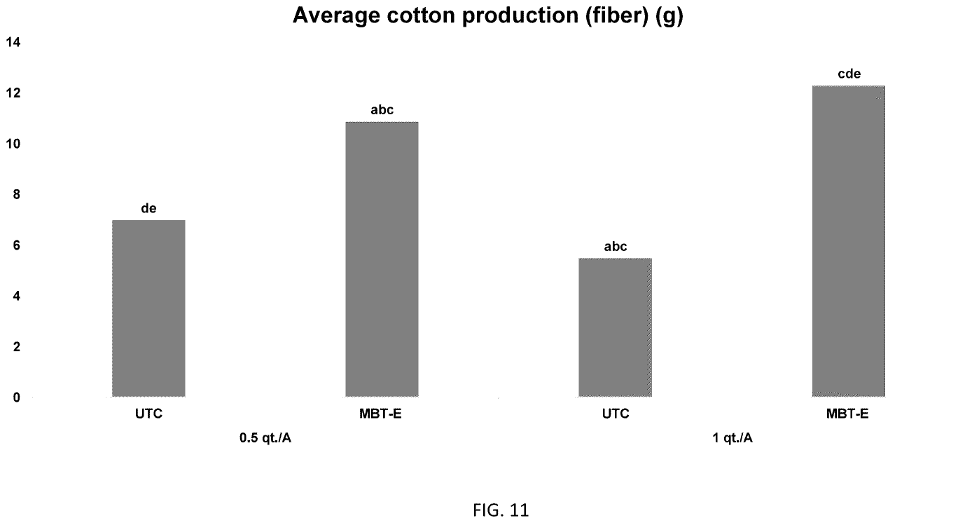

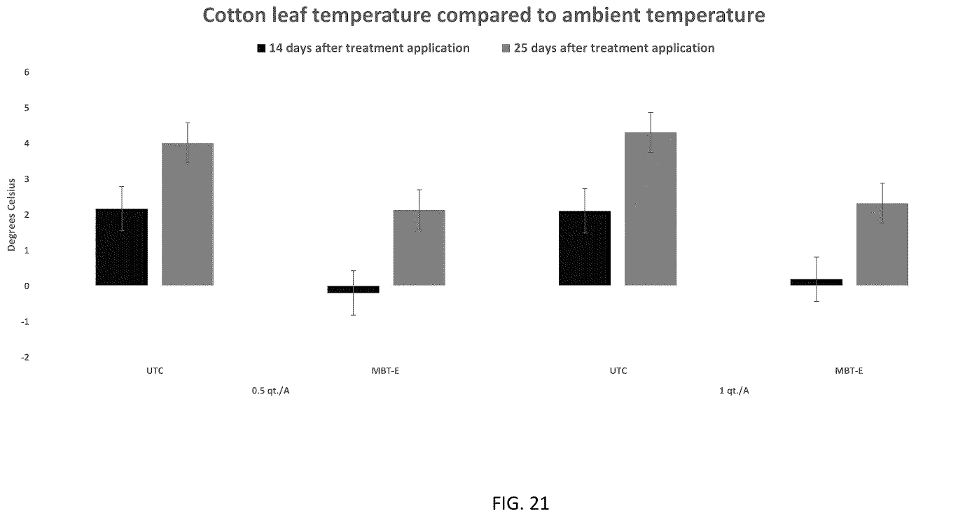

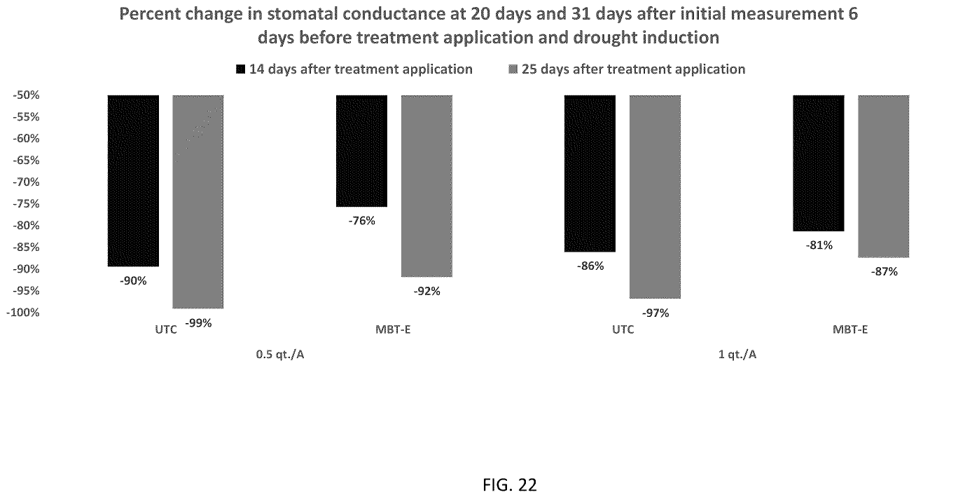

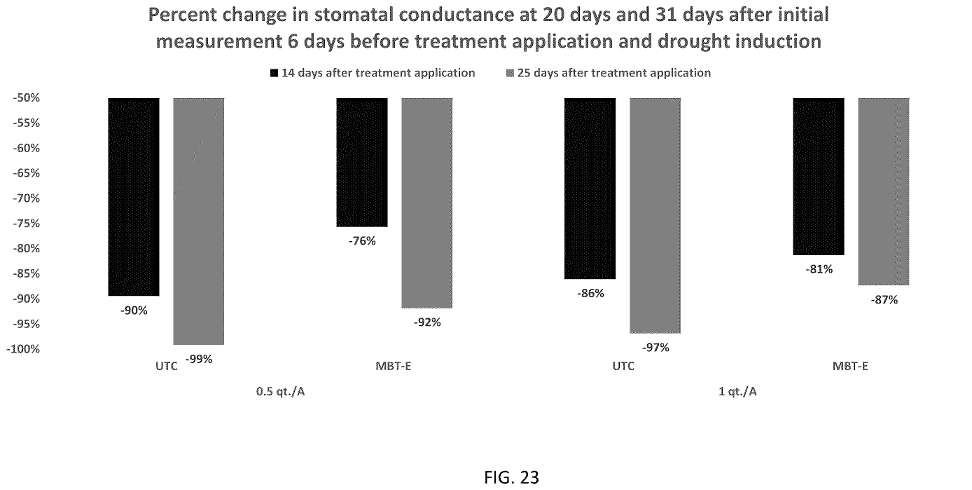

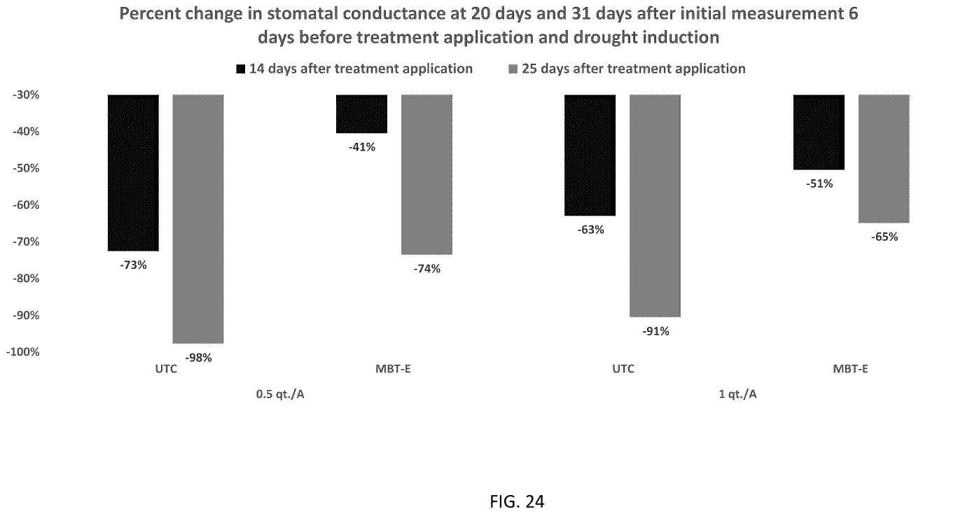

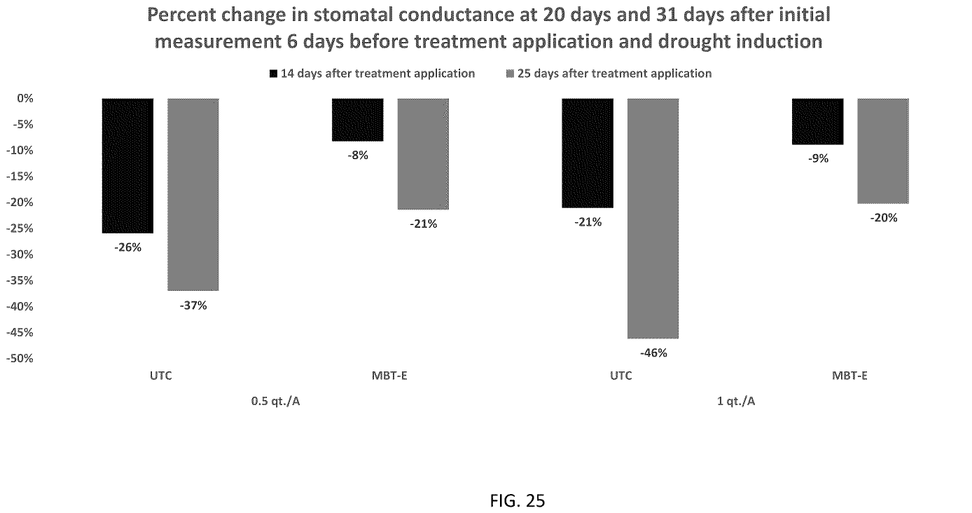

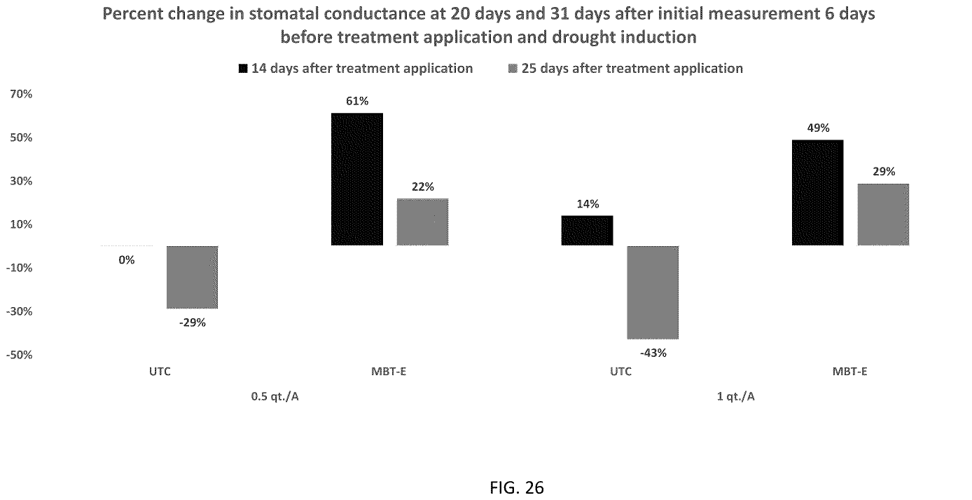

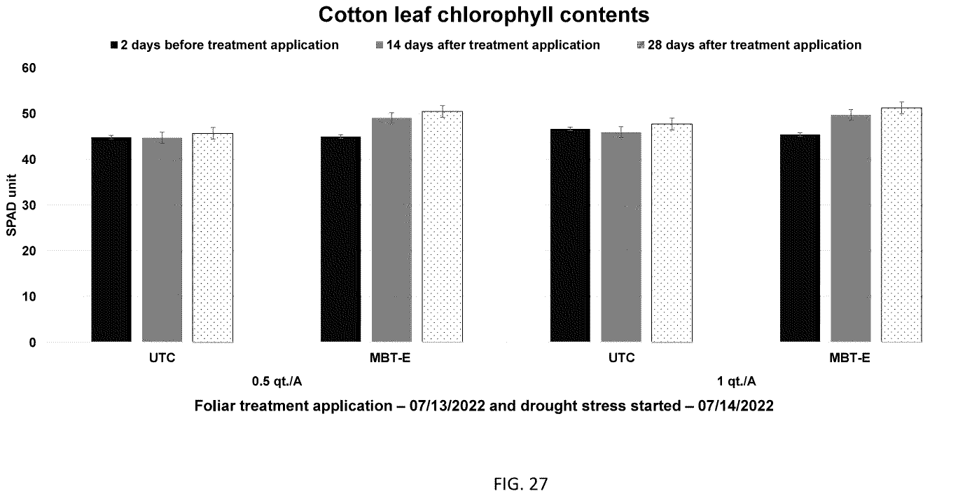

Drought stress alleviation in cotton experiment: MBT-E BP treated plants performed better than the untreated control in drought stress alleviation in cotton in a rainout shelter test at 0.5 and 1 qt./A rates. All the plant physiological parameters such as stomatal conductance, transpiration rate, quantum yield, electron transport rate, leaf chlorophyll contents, and prolines were increased by treating plants with MBT-E during drought stress period. The effects on cotton leaf temperature are shown in FIG. 21 and FIG. 22. The effects on stromal conductance are shown in FIG. 23. The effects on transpiration rate are shown in FIG. 24. The effects on quantum yield (% of light energy intercepted that is used in photosynthesis and not lost as heat) are shown in FIG. 25. The effects on electron transport rate are shown in FIG. 26. The effects on leaf chlorophyll contents are shown in FIG. 27. The SPAD readings (leaf chlorophyll contents) ranged from 44 to 51 and the highest leaf chlorophyll contents were found in plants treated with MBT-E under drought stress conditions. The SPAD readings for MBT-E were 50.46 at 0.5 qt./A rate and 51.25 at 1 qt./A rate that were recorded 15 days after drought stress water regimen initiated (FIG. 7; Table 2). The leaf temperature was reduced in plants treated with MBT-E compared to the untreated control. The ambient leaf temperatures were 2.13° C. at 0.5 qt./A rate and 2.31° C. at 1 qt./A rate for the MBT-E treated plants. MBT-E treated plants had higher concentrations of proline than the untreated control. The proline concentrations of MBT-E treated plants were 28.66 at 0.5 qt./A rate and 27.75 at 1 qt./A rate on 30 days after drought stress water regimen initiated (FIG. 8). The cotton boll production increased more in plants that were treated with MBT-E at 1 qt./A rate than the untreated control. The average cotton plant heights were 61.15 cm at 0.5 qt./A rate and 62.35 cm at 1 qt./A rate for MBT-E treated plants (FIG. 9). The average cotton bolls produced per plant 45 for MBT-E (FIG. 10). The MBT-E treated plants significantly increased cotton production at 0.5 and 1 qt./A (FIG. 11).

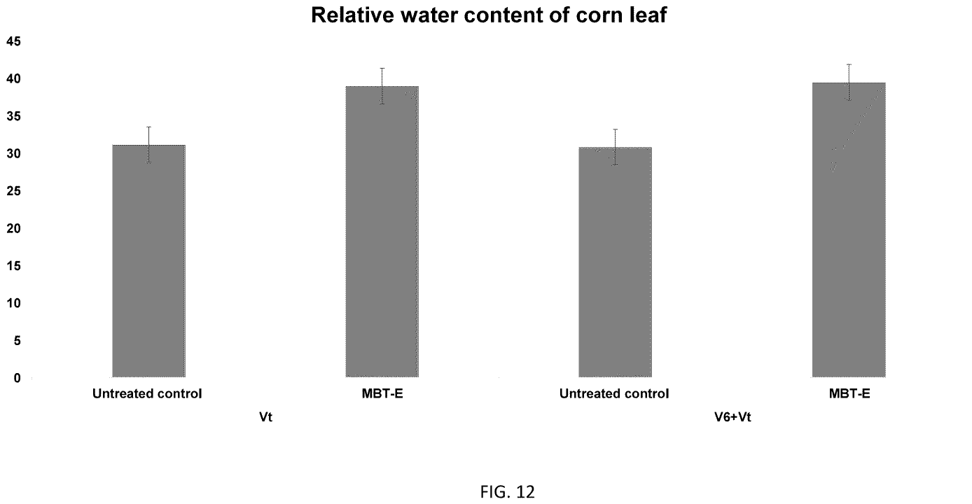

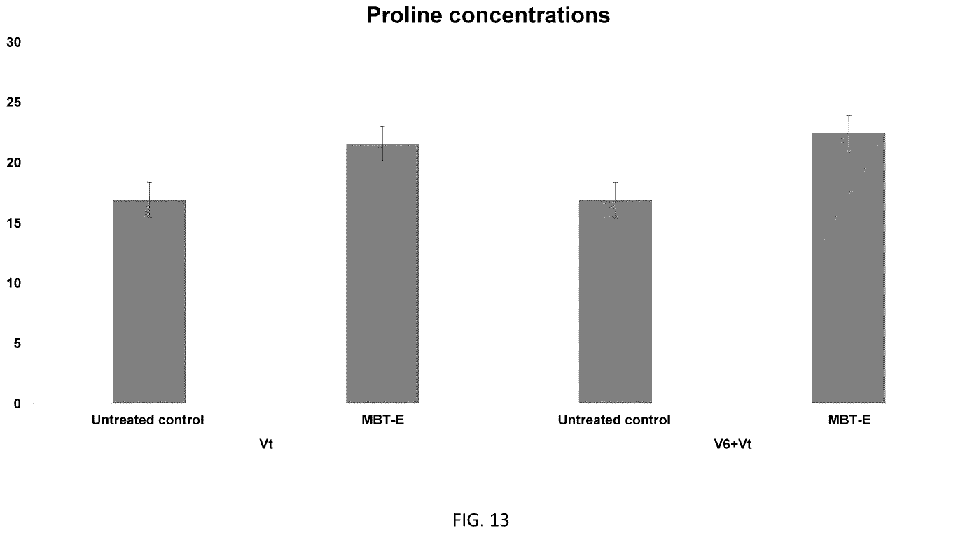

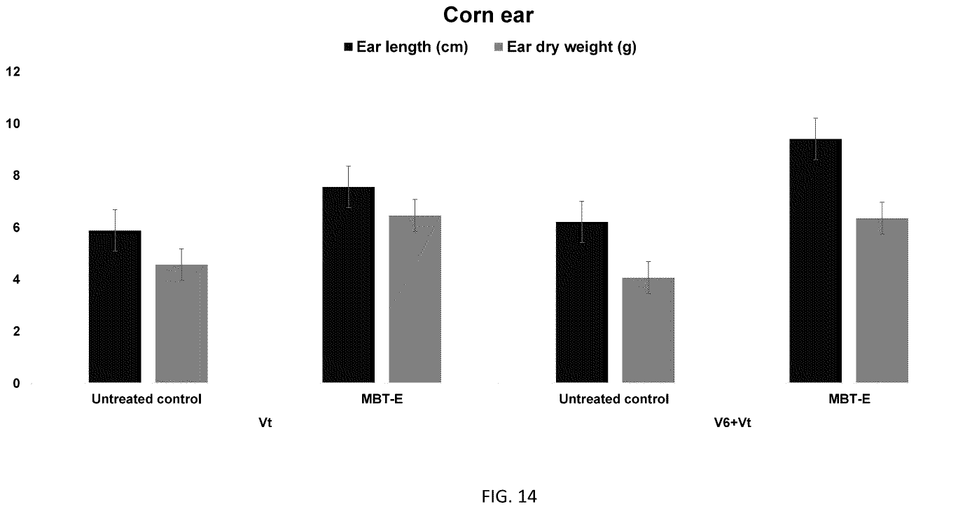

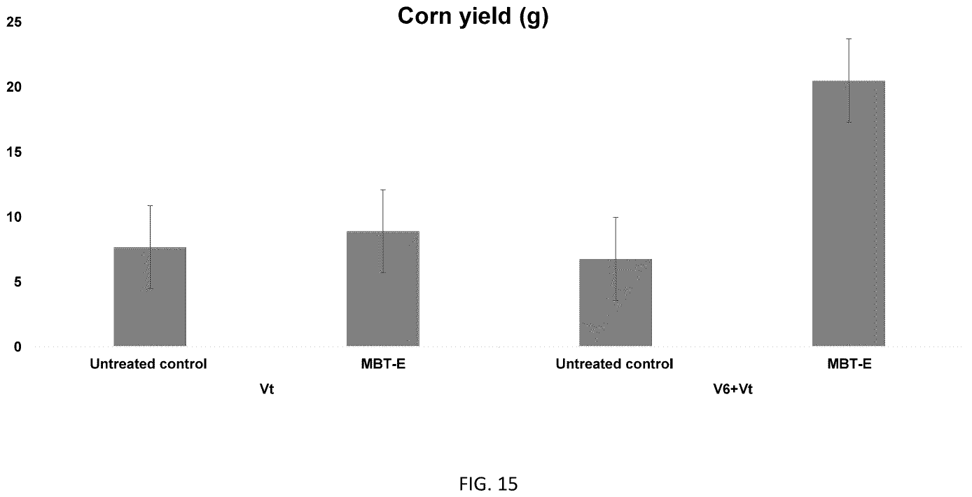

Drought stress alleviation in corn experiment: The same trend also was observed in drought stress alleviation in corn by applying MBT-E at vegetative growth 6 (V6) and vegetative tasseling (Vt) stages. The stomatal conductance of MBT-E treated plants was higher than the untreated control plants at V6 growth stage. The transpiration rate of MBT-E treated plants was increased more than untreated control plants at V6+Vt growth stage. The quantum yield and electron transport rate of MBT-A and E treated plants were increased than the untreated control. All the MBT-E treated plants had reduced the leaf temperature during the drought stress. The MBT-E treated plants had lower leaf temperature at Vt growth stage than untreated control. The ambient leaf temperatures were 0.38, 0.37, 0.11, and 0.15° C. at Vt growth stage for MBT-E (Table 3). The SPAD readings (leaf chlorophyll contents) were ranges from 18 to 51 and the highest leaf chlorophyll contents were found in plants treated with MBT-E under drought stress conditions at V6+Vt growth stage (Table 4). The relative leaf water content (%) of MBT-E treated plants was higher than the untreated control at V6 and V6+Vt growth stages (FIG. 12). The proline concentrations of MBT-E were 21.50 at Vt growth stage and 22.44 at V6+Vt growth stage on 30 days after drought stress water regimen initiated (FIG. 13). Corn ear length and dry weight were increased with MBT-E treatment (FIG. 14). The highest average corn grain yield was observed in plants that were treated with MBT-E at V6+Vt growth stage (FIG. 15).

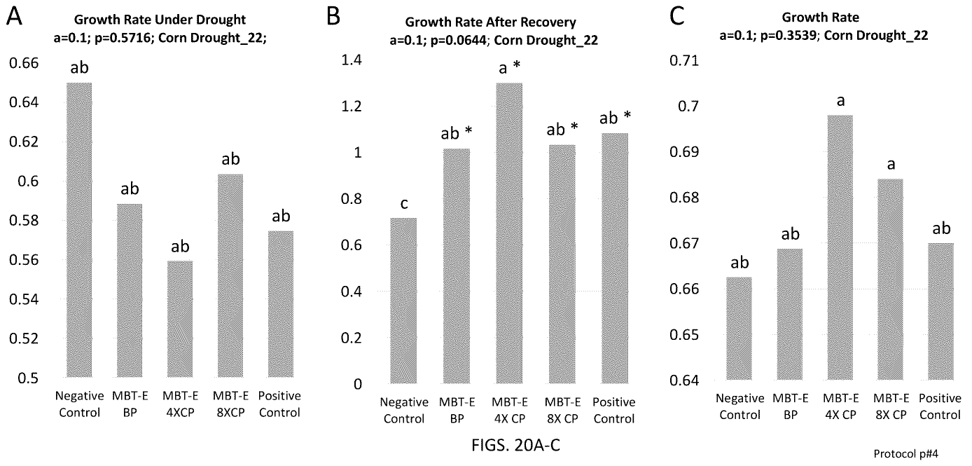

In another experiment, the effects of MBT-E BP, 4×, and 8× treatment on corn growth rates in drought stress conditions were tested by the following experiment: Corn, variety WS095 2021, was germinated in Berger All-purpose planting mix in a growth chamber at 22° C. for 14 days. They were maintained at 100% water capacity. At 14 days, they were fertilized with Jacks fertilizer. Treatments were applied as foliar treatments with 10 ml total per treatment being provided to each plant. The treated plants were placed in a lighted growth chamber at 22° C. for 14 days. Each plant was maintained at 30% water capacity to create water stress. The treatments were all filter sterilized and applied at 0.8% dilutions with filter sterilized water. Treatments were: 1) water as a negative control, 2) AccomplishLM™ as a positive control, MBT-E base product (BP), MBT-E BP concentrated 4-fold (4×CP) and MBT-E BP concentrated 8-fold (8×CP). A single plant was a replicate, and there were 7 replicates per treatment. Plant metrics were analyzed after 14 days. The results are shown in FIGS. 20A-C.

### Example 3: Plant Growth Promoting Properties of MBT-E Tested in Arabidopsis

MS medium used in these Examples was prepared by adding 4.43 g of MS basal salts (Murashige and Skoog Basal Medium, Sigma Aldrich, M5519), 0.2 g of myo-inositol, 1 g of MES, and 20 g of sucrose to 2 L of water. The pH was then adjusted to 5.7. 500 ml of the resulting solution was poured into each of 4 glass bottles with 1.77 g of Phytagel. The bottles were autoclaved, and the media was poured into petri dishes and allowed to solidify. If the goal was to collect data from roots, treated seedlings were grown on a 0.01% MS medium, with the addition of 0.66 g/l CaCl2) and 3.4 g/l Phytagel, which was adjusted to pH 5.7 prior to autoclaving. Media was then poured into petri dishes for solidification. If the goal was to collect shoot data, then the MS medium used in the treatment preparation was a liquid MS medium comprised of MS basal salts plus 2 g/l MES.

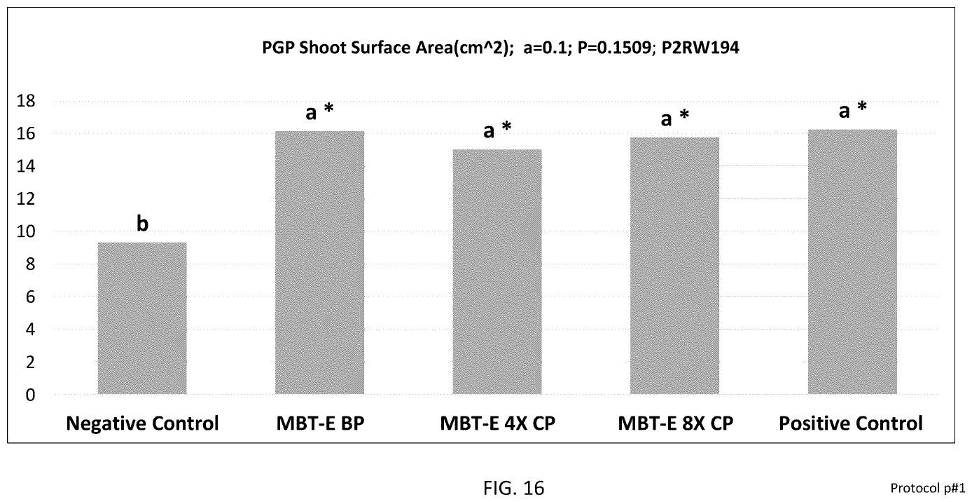

The effect of MBT-E BP, 4×, and 8× treatment on shoot surface area in Arabidopsis was tested by the following experiment: Surface sterilized Arabidopsis thaliana seeds were germinated for 7 days at 20° C. on plates containing MS medium solidified with phytagel. Seeds were then placed onto rockwool cubes which were moistened with 40 ml of each treatment. The treatments were all filter sterilized and applied at 0.8% dilutions with filter sterilized water. Treatments were: 1) water as a negative control, 2) a commercially available biostimulant, AccomplishLM™ as a positive control, MBT-E base product (BP), MBT-E BP concentrated 4-fold (4×CP) and MBT-E BP concentrated 8-fold (8×CP) which had been diluted to 0.8% in liquid MS medium. Four rock wool cubes, each with one seedling, constituted a replicate. Each treatment had four replicates. The treated plants were placed on LED grow carts in completed randomized block design and grown for 14 days at approximately 20° C. The cubes were kept moist by adding 8 mls of water every 2 days. After 14 days, the leaf area of each plant was measured using ImageJ software of shoot photographic images. The results are shown in FIG. 16. All treatments of MBT-E resulted in a significant increase in shoot surface area.

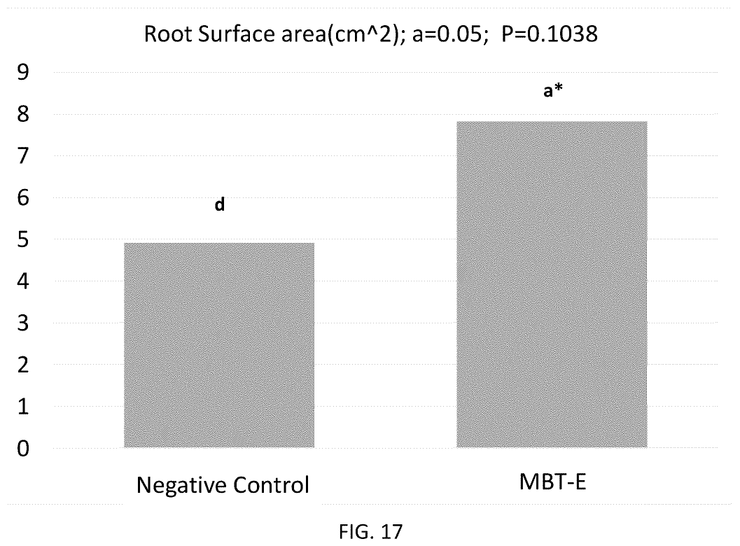

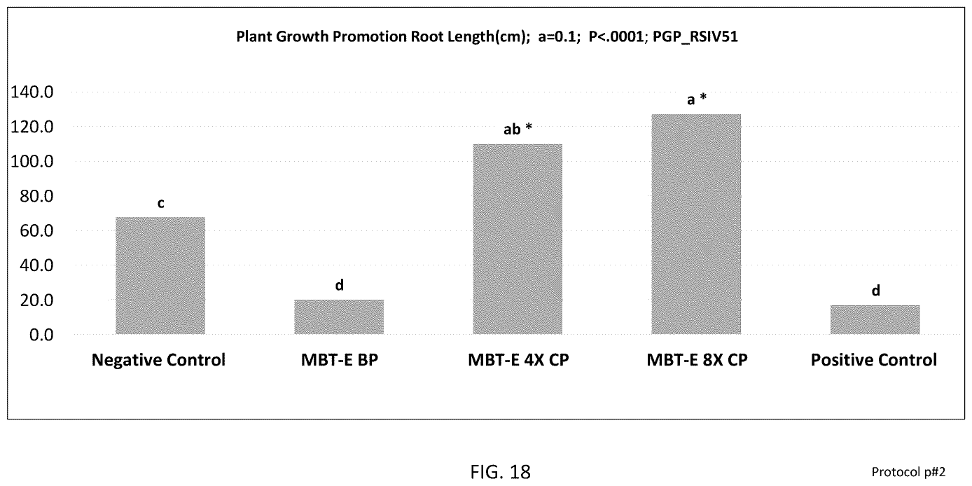

The effects of MBT-E BP, 4×, and 8× treatment on root length in Arabidopsis were tested by the following experiment: Surface sterilized Arabidopsis thaliana seeds were germinated for 6 days at 20° C. on plates containing MS medium solidified with phytagel. Seeds were treated by dipping each seedling root into its respective treatments. Treatments were: 1) water as a negative control, 2) AccomplishLM™ as a positive control, MBT-E base product (BP), MBT-E BP concentrated 4-fold (4×CP) and MBT-E BP concentrated 8-fold (8×CP) which had been diluted to 0.8% in liquid MS medium. Treated seedlings were then placed onto water agar plates (3 seedlings per plate constituted a replicate) containing 0.01% v/v Bromocresol purple. There were 4 replicates per treatment. The treatments and replicates were placed on LED grow carts in a complete randomized block design and grown for 12 days at approximately 20° C. After 7 days, the root area of each plant was measured by scanning and using WinRhizo software. The results are shown in FIG. 17 and FIG. 18. Asterisks indicate statistical significance.

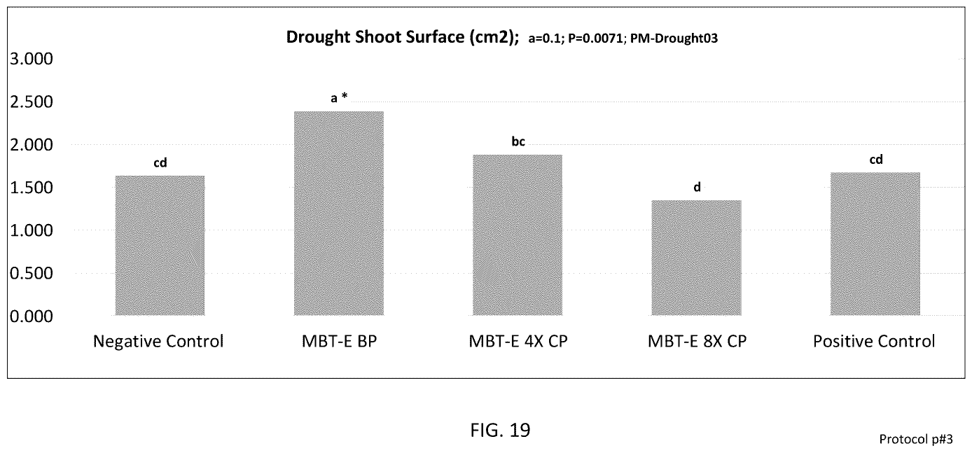

The effects of MBT-E BP, 4×, and 8× treatment on Arabidopsis in drought stress conditions were tested by the following experiment: Surface sterilized Arabidopsis thaliana seeds were germinated for 7 days at 20° C. on plates containing MS medium solidified with phytagel. One treated seed each were then placed into medicine cups containing peatmoss which were moistened with 30 ml of a treatment. The treatments were all filter sterilized and applied at 0.8% dilutions with filter sterilized water. Treatments were: 1) water as a negative control, 2) AccomplishLM™ as a positive control, MBT-E base product (BP), MBT-E BP concentrated 4-fold (4×CP) and MBT-E BP concentrated 8-fold (8×CP). Four medicine cups, each with one seedling, constituted a replicate. Each treatment had four replicates. The treated plants were placed in a lighted growth chamber (Percival Model 136LL) at 22° C. for 14 days. Water stress was created by maintaining the seedlings at 20% water capacity. LED grow carts in completed randomized block design and grown for 14 days at approximately 20° C. After 12 days, the leaf area of each plant was measured using ImageJ software of shoot photographic images. The results are shown in FIG. 19. Asterisks indicate statistical significance.

### Example 4: Effects of MBT-E in Cold Stress Conditions

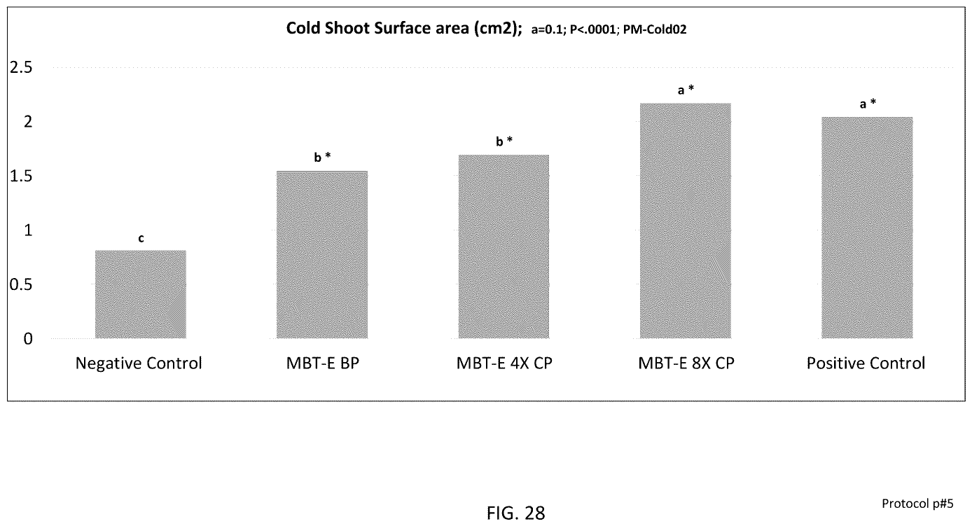

The effects of MBT-E on Arabidopsis in cold stress conditions were tested by the following experiment: Surface sterilized Arabidopsis thaliana seeds were germinated for 7 days at 20° C. on plates containing MS medium solidified with phytagel. One treated seed each were then placed into medicine cups containing peatmoss which were moistened with 30 ml of a treatment. The treatments were all filter sterilized and applied at 0.8% dilutions with filter sterilized water. Treatments were: 1) water as a negative control, 2) AccomplishLM™ as a positive control, MBT-E base product (BP), MBT-E BP concentrated 4-fold (4×CP) and MBT-E BP concentrated 8-fold (8×CP). Four medicine cups, each with one seedling, constituted a replicate. Each treatment had four replicates. The treated plants were placed in a lighted growth chamber (Percival Model LT41VL) at 12° C. for 21 days using a complete randomized block design. Observations were made at 14 and 21 days. The leaf area of each plant was measured using ImageJ software of shoot photographic images. The results for shoot surface area after cold treatment are shown in FIG. 28. Asterisks indicate statistical significance.

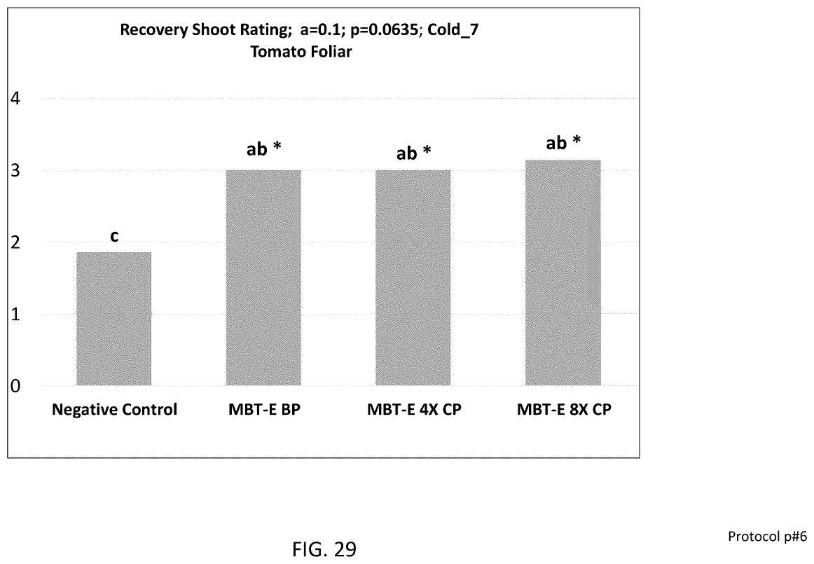

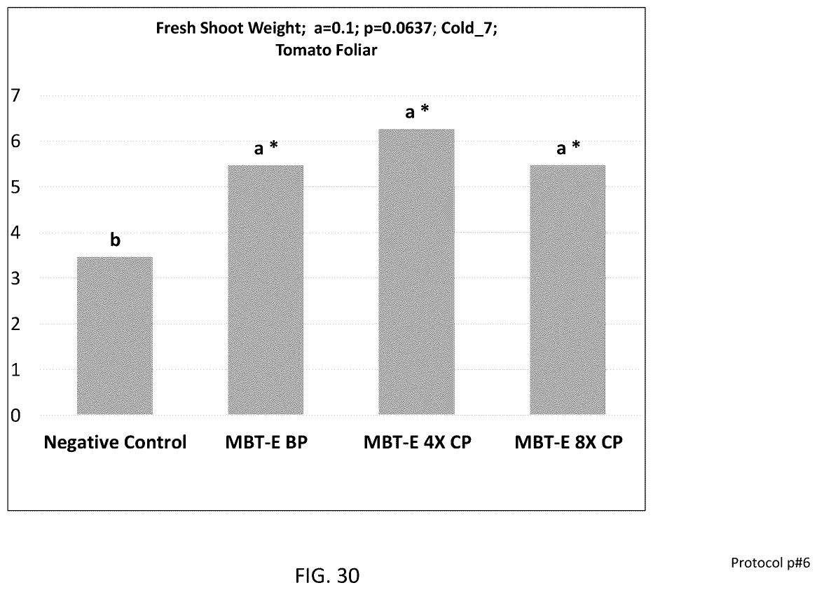

The effects of MBT-E on tomato in cold stress conditions was tested by the following experiment: Tomato, variety Rutgers, was germinated in Berger All-purpose mix and grown in a growth chamber (Percival Model 136LL) at 22° C. for 14 days. They were maintained at 100% water capacity. Fourteen days after planting, they were fertilized with Jacks fertilizer. Treatments were provided as foliar applications, with each plant receiving a total of 10 ml of treatment solution. Treatments were: 1) water as a negative control, 2) MBT-E base product (BP), 3) MBT-E BP concentrated 4-fold (4×CP) and 4) MBT-E BP concentrated 8-fold (8×CP). Treated plants were placed in a complete randomized block design in a lighted growth chamber (Percival Model LT41VL) which was programed to provide cold stress by first providing 16° C. for 1 hr, 8° C. for 1 hr, 4° C. for 2 hrs and −4° C. for 2 hrs. After this cold regime, plants were evaluated using a cold stress rating scale of 0-5 where 0 indicated no observed shoot stress and 5 indicated complete shoot death. The results for the cold stress rating are shown in FIG. 29. The results for recovery fresh weight are shown in FIG. 30.

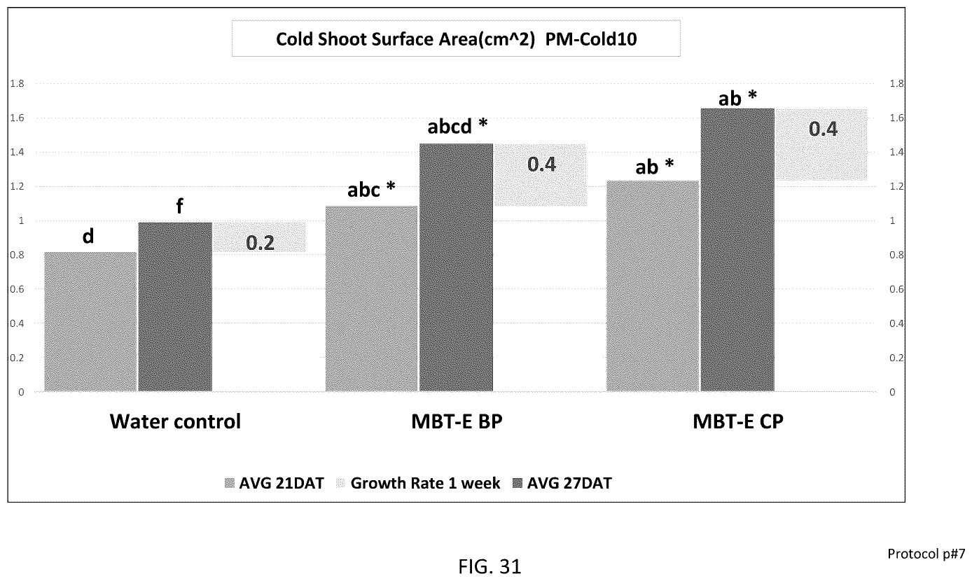

Further cold stress effects in Arabidopsis were tested by the following experiment: Surface sterilized Arabidopsis thaliana seeds were germinated for 7 days at 20° C. on plates containing MS medium solidified with phytagel. One treated seed each was then placed into medicine cups containing peatmoss which were moistened with 30 ml of a treatment. The treatments were all filter sterilized and applied at 0.8% dilutions with filter sterilized water. Treatments were: water as a negative control, MBT-E base product (BP), and MBT-E BP concentrated 4-fold (4×CP). Four medicine cups, each with one seedling, constituted a replicate. Each treatment had four replicates. The treated plants were placed in a lighted growth chamber at 12° C. for 21 days using a complete randomized block design. Observations were made at 14, 21, and 27 days after treatment (DAT). The leaf area of each plant was measured using ImageJ software of shoot photographic images. The results for shoot surface area are shown in FIG. 31.

### Example 5: Effects of MBT-E on Salt Tolerance

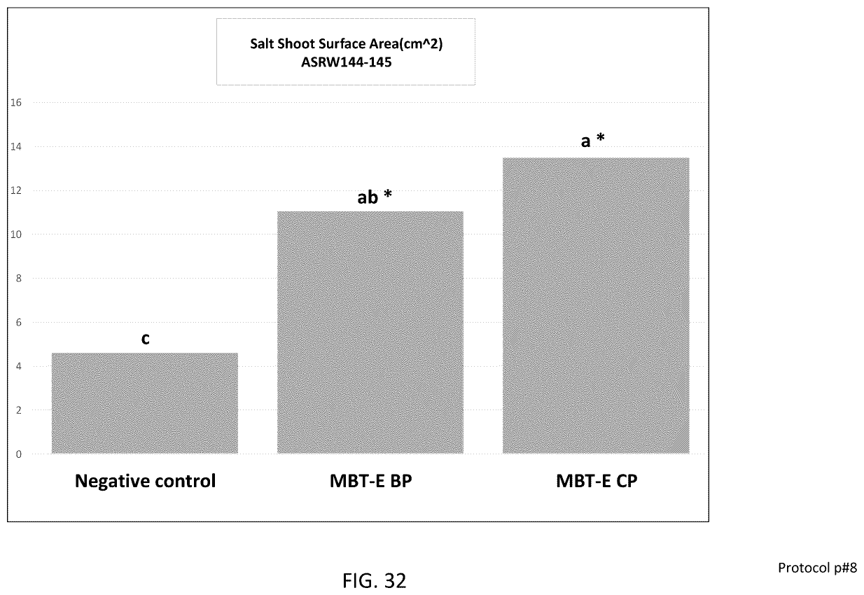

The effect of MBT-E on salt tolerance was tested by the following experiment: Surface sterilized Arabidopsis thaliana seeds were germinated for 7 days at 20° C. on plates containing MS medium solidified with phytagel. Seeds were then placed onto rockwool cubes which were moistened with 40 ml of each treatment. The treatments were all filter sterilized and applied at 0.2% dilutions with filter sterilized water. Treatments were: water as a negative control, MBT-E base product (BP) and MBT-E BP concentrated 4-fold (4×CP). All treatments also contained 75 mM NaCl. Four rock wool cubes, each with one seedling, constituted a replicate. Each treatment had four replicates. The treated plants were placed on LED grow carts in completed randomized block design and grown for 14 days at approximately 20° C. The cubes were kept moist by adding 8 ml of water every 2 days. After 14 days, the leaf area of each plant was measured using ImageJ software of shoot photographic images. The results are shown in FIG. 32.

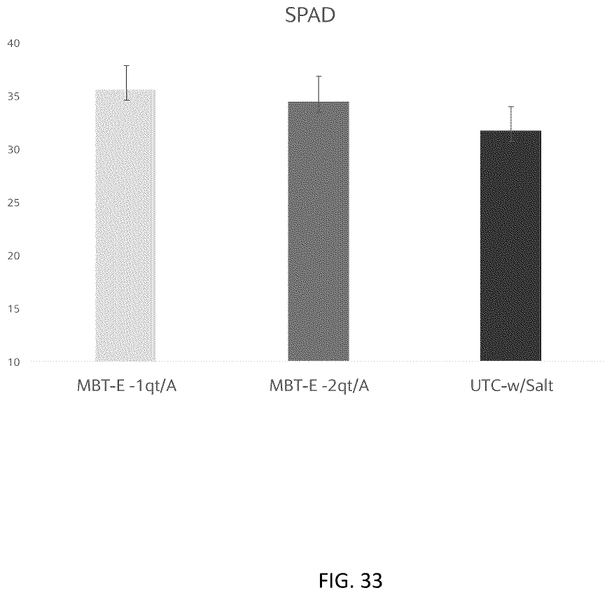

The effect of MBT-E on salt tolerance in corn was tested by the following experiment: Dynagro corn seed was planted in a 4:1 MVP turface/Sungro Blackgold peat media. Corn was thinned for uniformity 12 days after planting, fertilized with Jack's 20-20-20 at 25 lbs N/A, and salt stressed with 75 millimoles of NaCl. A foliar application of MBT-E was applied at 1 qt/A and 2 qt/A at 21 days after planting. SPAD, imaging, and LiCor measurements were taken at 3 dates before harvesting the corn for biomass. The results for leaf chlorophyll content (SPAD) are shown in FIG. 33.

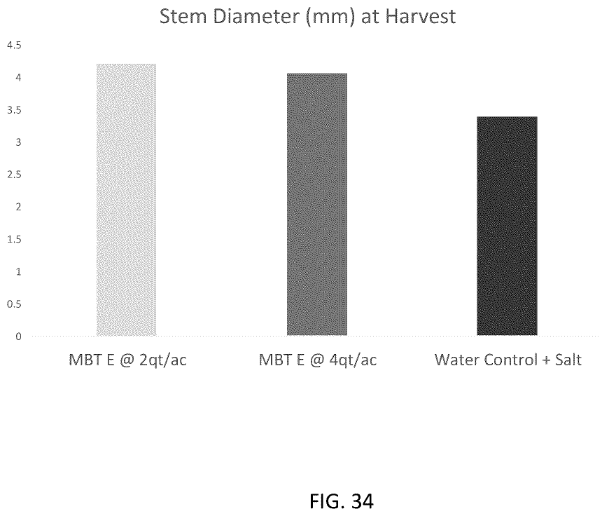

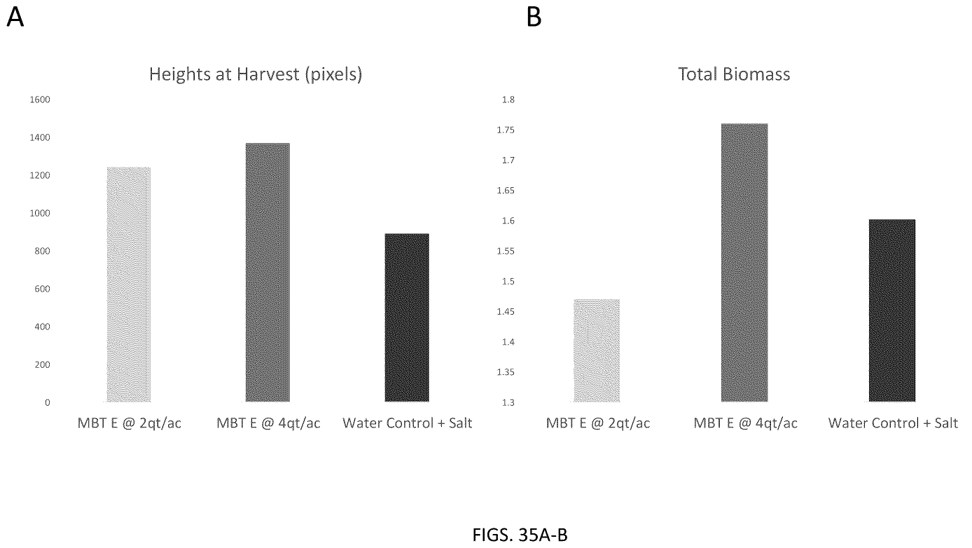

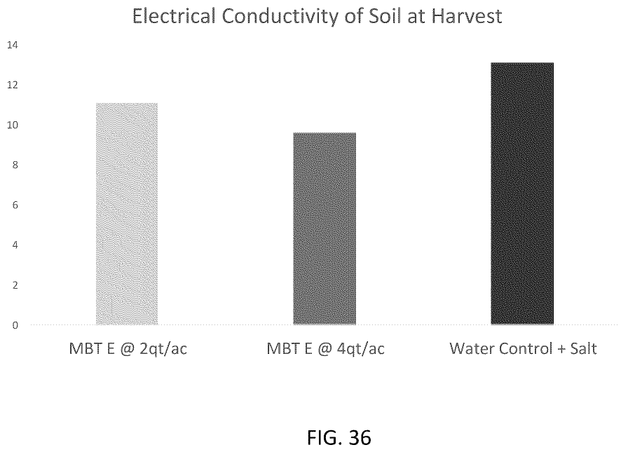

The effect of MBT-E on salt tolerance in Zinnia was tested by the following experiment: Dwarf Zinnia elegans seeds were planted in a 3:1 Isolite/Sunshine Mix LC1 peat media, thinned for uniformity and fertilized with Jack's 20-20-20 at 50 lbs/A. Electrical conductivity (EC) measurements of the soil were taken before seed planting and multiple times throughout the experiment. NaCl was applied at a total of 100 millimoles over three applications. MBT-E was applied as a foliar treatment 34 days after seeding at a rate of 1 qt/A and 2 qt/A. Metrics for this experiment included stem diameter, heights, total biomass, and a final EC reading of the soil at harvest. The results for the diameters of the stems at harvest are shown in FIG. 34. The results for height at harvest and total dry biomass are shown in FIGS. 35A-B. The results for electrical conductivity of the soil after treatment with MBT-E are shown in FIG. 36.

### Example 6: MBT-E Field Trial for Promotion of Bell Pepper Plant Growth

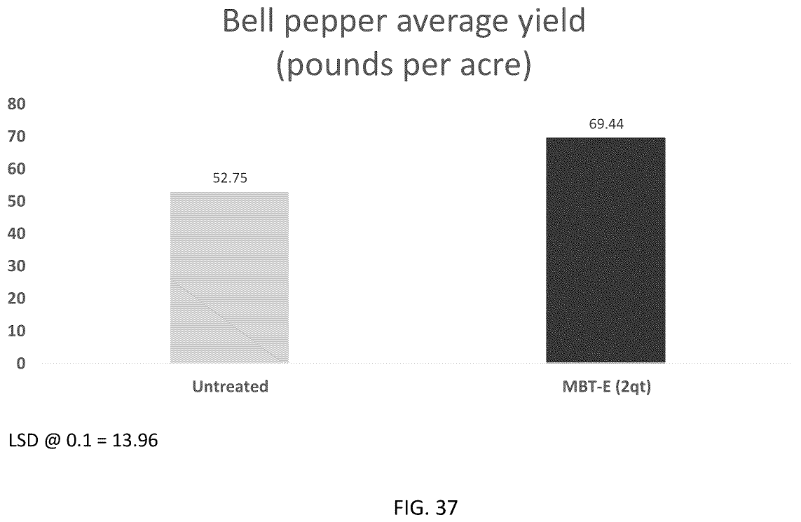

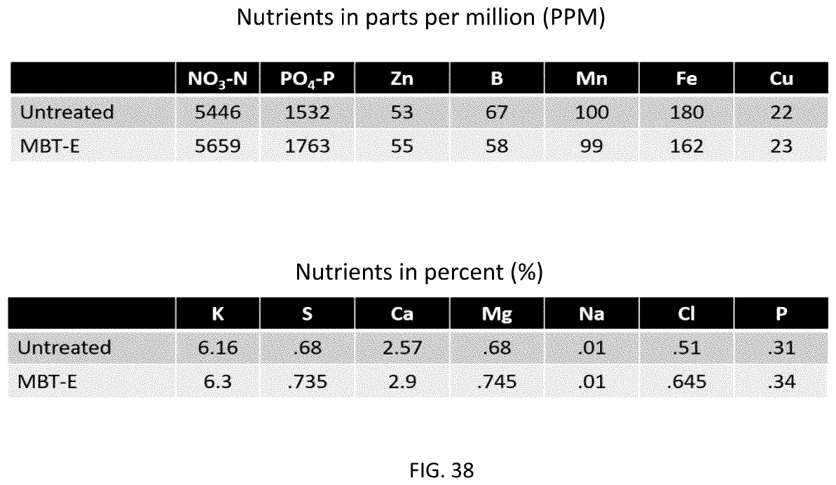

Bell pepper seedlings were transplanted into raised beds in Yuma, Arizona. Prior to planting, the beds were provided MAP (monoammonium phosphate) fertilizer at a rate of 300 lbs per acre. The control treatment (no added MBT-E) was planted as 4 replicates into two beds, with each replicate being 75 feet long. The MBT-E treatment was planted as 8 replicates in 4 beds with each replicate being 75 feet long. Three weeks after planting, the plants were fertigated with a subsurface drip system with UAN 32 (urea ammonium nitrate) fertilizer, with each treatment (no MBT-E addition or with MBT-E addition at 2 qts per acre). The no MBT-E and the MBT-E treatments were only provided at this initial fertilization time. Thereafter, the plants were provided fertilizer two more times over the growing season. Plants were harvested on Jun. 17, 2022. After harvest, yield (FIG. 37) and tissue nutrient data (FIG. 38) were collected. Leaf tissue from plants treated with MBT-E showed increase nitrogen, phosphorus and potassium levels relative the leaf tissue of control plants.

### Example 7: Microbial Population Analysis of Kelp Feedstocks and Biostimulant Products

Two different batches of the seaweed feedstock powders (Ecklonia maxima for MBT-E and Ascophyllum nodosum for MBT-A) with five or three technical replicates each, respectively, were sampled. DNA was extracted from 0.025 g powder using a bead-beating extraction and phenol chloroform cleanup. For the MBT-A 4× and MBT-E two or three different batches of solution were sampled with four or three technical replicates, respectively. 100 ml of the concentrated product solution were filtered, bacterial cells collected from the filter and then DNA extracted using the MP Biomedicals DNA Soil Pro Kit.

Amplicon-based DNA sequencing for samples was completed by Molecular Research (MRDNA, Shallowater, TX) using their standard methods for bacterial analyses using the 16S-515F primer, 20,000 reads per sample on the Illumina NovaSeq 6000 system. Additionally, MRDNA did QA/QC, chimera checking and OTU (operational taxonomic units) binning. Output from MRDNA was analyzed in the statistical analysis platform R using the vegan package for display of the community analysis profiles as UPGMA-based cluster analysis trees.

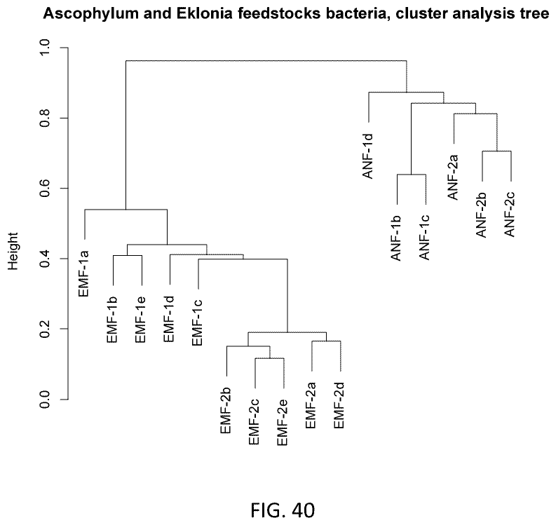

Cluster analysis trees for the Ascophyllum and Ecklonia feedstocks are shown in FIG. 40. The EMF and AMF feedstock powder bacterial communities are distinctly different. All the EMF community samples group together and originate from the same branch and show some slight separation and differences between the two batches of the EMF analyzed (1 and 2). However, these EMF samples are very similar to each other since they branch from one another. For the All the AMF community samples group together and originate from the same. The “Height” scale on the left side is analogous to percent differences between samples. The longer the branch, the more different samples are. Since, the EMF and AMF feedstock powder communities do not overlap in the same series of branches, it can be concluded that the EMF and AMF feedstock powders have different microbial communities.

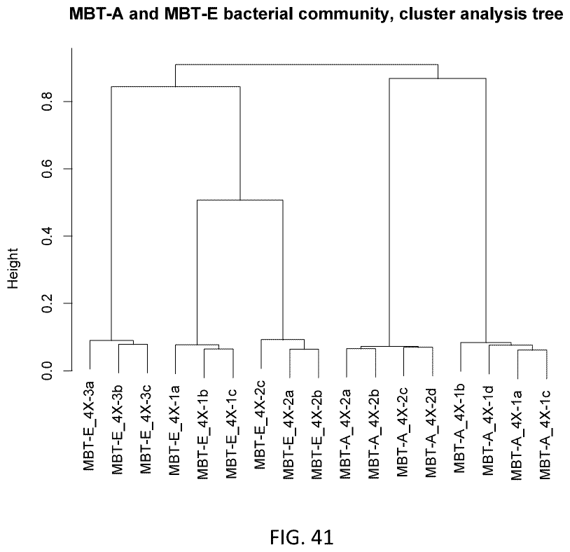

Cluster analysis trees for MBT-A and MBT-E are shown in FIG. 41. The MBT-E 4× and MBT-A 4× bacterial communities are distinctly different. The MBT-E and MBT-A communities are clearly separated and do not overlap in a series of branches. The three batches of MBT-E are very similar to each other, and the MBT-A-1 and 2 communities are more similar to each other than the MBT-A-3. These MBT-E batch communities do overlap in a series of branches.

TABLE 2
The plant physiological parameters, plant height, and cotton bolls production that were
recorded during the drought stress conditions in cotton (1 and 2 indicate the two different
data recording dates: 14 and 25 days after treatment application) (Stomatal conductance—gsw,
transpiration rate—E, Quantum yield—QY, Electron transport rate—ETR, leaf
chlorophyll contents—SPAD, Relative water contents—RWC, and temperature—T)

| Treatment | Rate | | gsw1 | gsw1 | E1 | E2 | QY1 | QY2 | ETR1 |
|---|---|---|---|---|---|---|---|---|---|
| Untreated | 0.5 | qt./A | 0.039936 | 0.00284 | 1.694 | 0.1341 | 0.4953098 | 0.4209 | 240.536 |
| control | | | | | | | | | |
| MBT-E | 0.5 | qt./A | 0.112762 | 0.037345 | 3.8833 | 1.7214 | 0.6318967 | 0.54106 | 320.997 |
| Untreated | 1 | qt./A | 0.040097 | 0.008776 | 1.7479 | 0.4414 | 0.5299897 | 0.36085 | 285.285 |
| control | | | | | | | | | |
| MBT-E | 1 | qt./A | 0.083765 | 0.056386 | 3.1874 | 2.2543 | 0.625238 | 0.547 | 316.754 |

| | | | | | | | Plant | Cotton |
|---|---|---|---|---|---|---|---|---|
| Treatment | ETR2 | T1 | T2 | SPAD1 | SPAD2 | Proline | height | bolls |
| Untreated | 171.032 | 2.1635 | 4.012 | 44.735 | 45.675 | 20.6 | 57.75 | 20 |
| control | | | | | | | | |
| MBT-E | 242.348 | −0.206 | 2.1325 | 49.035 | 50.465 | 28.66 | 61.15 | 30 |
| Untreated | 142.643 | 2.103 | 4.3145 | 45.905 | 47.695 | 21.31 | 57.85 | 13 |
| control | | | | | | | | |
| MBT-E | 274.003 | 0.18 | 2.3105 | 49.68 | 51.255 | 27.75 | 62.35 | 45 |

TABLE 3
The plant physiological parameters that were recorded during the drought
stress conditions in corn (1, 2, 3, and 4 indicate the four different data
recording dates: 10, 16, 30, and 37 days after treatment application)

| | Application | | | | | | | | | | |
|---|---|---|---|---|---|---|---|---|---|---|---|
| Treatment | time | gsw1 | gsw2 | gsw3 | gsw4 | E1 | E2 | E3 | E4 | QY1 | QY2 |
| Untreated | Vt | −0.0026 | 0.054 | 0.023 | 0.013 | −0.13 | 1.1 | 0.94 | 0.48 | 0.107 | 0.393 |
| control | | | | | | | | | | | |
| MBT-E | Vt | 0.022 | 0.089 | 0.067 | 0.057 | 0.79 | 2.35 | 1.51 | 1.99 | 0.34 | 0.53 |
| Untreated | V6 + Vt | 0.008 | 0.074 | 0.019 | 0.014 | 0.16 | 2.39 | 0.44 | 0.56 | 0.109 | 0.334 |
| control | | | | | | | | | | | |
| MBT-E | V6 + Vt | 0.061 | 0.127 | 0.11 | 0.06 | 1.59 | 3.91 | 2.18 | 1.7 | 0.34 | 0.481 |

| Treatment | QY3 | QY4 | ETR1 | ETR2 | ETR3 | ETR4 | T1 | T2 | T3 | T4 |
|---|---|---|---|---|---|---|---|---|---|---|
| Untreated | 0.303 | 0.127 | 46.33 | 152.55 | 166.97 | 109.48 | 3.1 | 3.1 | 1.85 | 1.25 |
| control | | | | | | | | | | |
| MBT-E | 0.51 | 0.397 | 112.2 | 222.42 | 172.42 | 178.93 | 0.38 | 0.37 | 0.11 | 0.15 |
| Untreated | 0.44 | 0.228 | 50.31 | 141.09 | 72.11 | 126.48 | 0.61 | 0.58 | 0.62 | 2.03 |
| control | | | | | | | | | | |
| MBT-E | 0.419 | 0.417 | 152.88 | 216.71 | 152.52 | 164.08 | 1.04 | 1.03 | 3.19 | 0.9 |

TABLE 4
The plant physiological parameters, relative water contents of leaf, and accumulation of proline
that were recorded during the drought stress conditions in corn (1, 2, 3, and 4 indicate the four
different data recording dates in 2021: 10, 16, 30, and 37 days after treatment application)

| | | | | | | | | Ear length | Ear dry | |
|---|---|---|---|---|---|---|---|---|---|---|
| Treatment | Application time | SPAD1 | SPAD2 | SPAD3 | SPAD4 | RWC (%) | Proline | (cm) | weight (g) | Yield |
| Untreated control | Vt | 38.31 | 45.9 | 26.16 | 23.68 | 31.16 | 16.8802 | 5.87 | 4.55 | 7.64 |
| MBT-E | Vt | 47.35 | 50.9 | 42.15 | 28.72 | 39.009 | 21.5059 | 7.55 | 6.45 | 8.87 |
| Untreated control | V6 + Vt | 42.75 | 37.85 | 20 | 18.73 | 30.84 | 16.8802 | 6.2 | 4.05 | 6.73 |
| MBT-E | V6 + Vt | 51.26 | 51.44 | 32.86 | 27.73 | 39.5 | 22.4425 | 9.4 | 6.35 | 20.47 |

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

What is claimed is:

1.-78. (canceled)

79. A method of making a biostimulant composition comprising:
(a) providing a digestion system comprising two or more containers in a series, wherein each of the two more containers comprises at least a portion of a fluid, wherein the fluid comprises at least a portion of an organic feedstock comprising Ecklonia maxima kelp; and
(b) operating the digestion system by:
(i) digesting the at least a portion of an organic feedstock comprising Ecklonia maxima kelp by a microbe;
(ii) transferring a first portion of the fluid from a first container of the series to a second container of the series; and
(iii) collecting the biostimulant composition from an outflow port of a container of the two or more containers.

80. The method of claim 79, wherein the digesting of (b)(i) is via anaerobic digestion.

81. The method of claim 79, wherein at least one of the two or more containers comprises a packed-bed reactor.

82. The method of 79, wherein the microbe is endogenous to the Ecklonia maxima kelp present in the organic feedstock.

83. The method of claim 82, wherein the microbe comprises a sporulated microbe.

84. The method of claim 79, wherein the microbe comprises one or more bacteria of a genus selected from the group consisting of Actinotalea, Agrobacterium, Dinoroseobacter, Frigoribacterium, Fucophilus, Halomonas, Hoeflea, Ketogulonicigenium, Loktanella, Luteimonas, Oceanicola, Octadecabacter, Opitutus, Ornithinimicrobium, Paracoccus, Phaeobacter, Pseudomonas, Rhodobacter, Roseobacter, Salinibacterium, and Serinicoccus.

85. The method of claim 79, wherein the organic feedstock further comprises a chitin or a yeast.

86. The method of claim 85, wherein the organic feedstock comprises the yeast, wherein the yeast is Saccharomyces cerevisiae yeast.

87. The method of claim 79, wherein the organic feedstock further comprises an aqueous slurry of the Ecklonia maxima kelp, a chitin, and a yeast.

88. The method of claim 79, further comprising removing the microbe from the biostimulant composition.

89. The method of claim 79, further comprising continuously flowing a first portion of the fluid from the first container to the second container.

90. The method of claim 89, further comprising continuously flowing a second portion of the fluid from the second container to a third container.

91. The method of claim 90, further comprising continuously flowing a third portion of the fluid from the third container to a fourth container.

92. The method of claim 79, further comprising agitating the at least the portion of the fluid in at least one container of the two or more containers, thereby allowing a biosolid of the fluid to settle to a bottom of the at least one container.

93. The method of claim 79, wherein the digesting of (b)(i) produces a digestion product comprising one or more of isobutanol, pentadecanenitrile, pentadecanoic acid, 9-octadecenenitrile, hexadecanenitrile, or heneicosane.

94. The method of claim 79, wherein the organic feedstock does not comprise Ascophyllum nodosum kelp.

95. The method of claim 79, further comprising filter sterilizing the biostimulant composition.

96. The method of claim 79, further comprising dehydrating the biostimulant composition.

97. The method of claim 79, wherein the biostimulant composition comprises rhamnose, fucose, xylose, mannose, glucose, or any combination thereof.

98. A composition comprising one or more digestion products produced by microbial digestion of an organic feedstock comprising Ecklonia maxima kelp by a microbe, wherein the microbe comprises one or more bacteria of a genus selected from the group consisting of Actinotalea, Agrobacterium, Dinoroseobacter, Frigoribacterium, Fucophilus, Halomonas, Hoeflea, Ketogulonicigenium, Loktanella, Luteimonas, Oceanicola, Octadecabacter, Opitutus, Ornithinimicrobium, Paracoccus, Phaeobacter, Pseudomonas, Rhodobacter, Roseobacter, Salinibacterium, and Serinicoccus.
